(19) United States
(12) Patent Application Publication
(10) Pub. No.: US 2018/0241126 A1
(43) Pub. Date: Aug. 23, 2018

(54) COIL ANTENNA, COIL-MOUNTED SUBSTRATE, RECORDING MEDIUM, AND ELECTRONIC APPARATUS

(71) Applicant: Murata Manufacturing Co., Ltd., Nagaokakyo-shi (JP)

(72) Inventor: Yoshifumi NOMURA, Nagaokakyo-shi (JP)

(21) Appl. No.: 15/955,734

(22) Filed: Apr. 18, 2018

Related U.S. Application Data
(63) Continuation of application No. PCT/JP2016/081244, filed on Oct. 21, 2016.

(30) Foreign Application Priority Data
Nov. 11, 2015 (JP) 2015-221324
Mar. 18, 2016 (JP) 2016-055885

(51) Int. Cl. H01Q 7/00; H01F 27/29; H01F 27/28

(52) U.S. Cl. CPC H01Q 7/00; H01F 2027/2809; H01F 27/2804; H01F 27/29

(57) ABSTRACT

A coil antenna includes a multilayer body including a first main surface that is perpendicular or substantially perpendicular to a lamination direction and an insulating layer, a coil conductor defined by a conductive body provided in or on the multilayer body with at least a portion of the multilayer body defining a core, first and second terminals provided on the first main surface and electrically connected to the coil conductor, wherein the first terminal covers at least a portion of a point at an L/4 position from one end of the first main surface in a lengthwise direction and the second terminal covers at least a portion of a point at an L/4 position from the other end of the first main surface in the lengthwise direction when a length of the first main surface in the lengthwise direction is L.

### CROSS REFERENCE TO RELATED APPLICATIONS

This application claims the benefit of priority to Japanese Patent Application No. 2016-055885 filed on Mar. 18, 2016 and Japanese Patent Application No. 2015-221324 filed Nov. 11, 2015 and is a Continuation Application of PCT Application No. PCT/JP2016/081244 filed on Oct. 21, 2016. The entire contents of each application are hereby incorporated herein by reference.

### BACKGROUND OF THE INVENTION

### 1. Field of the Invention

The present invention relates to a coil antenna, a coil-mounted substrate, a recording medium, and an electronic apparatus.

### 2. Description of the Related Art

An inductor element including a coiled conductor pattern can be used as a coil antenna. Japanese Unexamined Patent Application Publication No. 2014-207432 discloses an example of the inductor element. In the inductor element disclosed in Japanese Unexamined Patent Application Publication No. 2014-207432, a plurality of pad electrodes are formed on one main surface of a multilayer body. Two pad electrodes at both ends among the plurality of pad electrodes are electrically connected to a coiled conductor pattern provided in the multilayer body. When the element is mounted on a substrate, soldering or the like is performed between the plurality of pad electrodes arranged on the one main surface of the multilayer body and electrodes arranged on a substrate side.

In the inductor element disclosed in Japanese Unexamined Patent Application Publication No. 2014-207432, the two pad electrodes that are electrically connected to the coiled conductor pattern are arranged at positions closer to both ends on the one main surface of the multilayer body.

The multilayer body is warped in some cases depending on a process of manufacturing the element. Japanese Unexamined Patent Application Publication No. 2014-207432 discloses an invention to eliminate the warpage but the invention disclosed in Japanese Unexamined Patent Application Publication No. 2014-207432 can possibly not be executed due to some limitations. When the inductor element is attempted to be mounted on the substrate in a state in which the multilayer body is warped, the two electrodes necessary to energize the coil are separated from the substrate and cannot be sufficiently connected to the electrodes on the substrate in some cases even in a state in which the multilayer body is made to abut against the substrate.

### SUMMARY OF THE INVENTION

Preferred embodiments of the present invention provide coil antennas that enable connection of electrodes when the coil antennas are mounted on substrates even if warpage is generated, and coil-mounted substrates, recording media, and electronic apparatuses including such coil antennas.

A coil antenna according to a preferred embodiment of the present invention includes a multilayer body including a first main surface which faces an outer side portion and is perpendicular or substantially perpendicular to a lamination direction, and an insulating layer, a coil conductor having a coil shape and including a conductive body provided in the multilayer body or on a surface of the multilayer body, at least a portion of the multilayer body defining a core, a first terminal provided on the first main surface and being electrically connected to the coil conductor, and a second terminal provided on the first main surface and being electrically connected to the coil conductor, wherein the first terminal covers at least a portion of a point at an L/4 position from one end of the first main surface in a lengthwise direction and the second terminal covers at least a portion of a point at an L/4 position from the other end of the first main surface in the lengthwise direction when a length of the first main surface in the lengthwise direction is L.

Preferred embodiments of the present invention provide coil antennas that enable connection of electrodes when the coil antenna is mounted on a substrate even if warpage is generated because a first terminal and a second terminal necessary for electrical connection are prevented from significantly floating up from the surface of the substrate.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a first perspective view of a coil antenna according to a first preferred embodiment of the present invention.

FIG. 2 is a second perspective view of the coil antenna according to the first preferred embodiment of the present invention.

FIG. 3 is a plan view of the coil antenna according to the first preferred embodiment of the present invention.

FIG. 4 is a side view of the coil antenna according to the first preferred embodiment of the present invention.

FIG. 5 is a partially enlarged view of FIG. 4.

FIG. 6 is a bottom view of the coil antenna according to the first preferred embodiment of the present invention.

FIG. 7 is a schematic view of a connection relation of conductive bodies included in the coil antenna according to the first preferred embodiment of the present invention.

FIG. 8 is a partial plan view of a first example of the coil antenna according to the first preferred embodiment of the present invention.

FIG. 9 is a partial plan view of a second example of the coil antenna according to the first preferred embodiment of the present invention.

FIG. 10 is a lamination view of the coil antenna according to the first preferred embodiment of the present invention.

FIG. 11 is a first descriptive view for explaining a method for manufacturing respective layers included in the coil antenna according to the first preferred embodiment of the present invention.

FIG. 12 is a second descriptive view for explaining the method for manufacturing the respective layers included in the coil antenna according to the first preferred embodiment of the present invention.

FIG. 13 is a third descriptive view for explaining the method for manufacturing the respective layers included in the coil antenna according to the first preferred embodiment of the present invention.

FIG. 14 is a fourth descriptive view for explaining the method for manufacturing the respective layers included in the coil antenna according to the first preferred embodiment of the present invention.

FIG. 15 is a descriptive view of a first example in which the coil antenna according to the first preferred embodiment of the present invention is mounted on a substrate in a warped state.

FIG. 16 is a descriptive view of a second example in which the coil antenna according to the first preferred embodiment of the present invention is mounted on the substrate in a warped state.

FIG. 17 is a descriptive view for explaining a positional relation among a first terminal, a second terminal, a first connection point, and a second connection point.

FIG. 18 is a first descriptive view for explaining a positional relationship between a magnetic flux generated from the coil antenna and the two terminals.

FIG. 19 is a second descriptive view for explaining a positional relationship between the magnetic flux generated from the coil antenna and the two terminals.

FIG. 20 is a plan view of a first variation of the coil antenna according to the first preferred embodiment of the present invention.

FIG. 21 is a plan view of a second variation of the coil antenna according to the first preferred embodiment of the present invention.

FIG. 22 is a side view of a third variation of the coil antenna according to the first preferred embodiment of the present invention.

FIG. 23 is a first perspective view of a coil antenna according to a second preferred embodiment of the present invention.

FIG. 24 is a second perspective view of the coil antenna according to the second preferred embodiment of the present invention.

FIG. 25 is a plan view of the coil antenna according to the second preferred embodiment of the present invention.

FIG. 26 is a lamination view of the coil antenna according to the second preferred embodiment of the present invention.

FIG. 27 is a plan view of a variation on the coil antenna according to the second preferred embodiment of the present invention.

FIG. 28 is a first perspective view of a coil antenna according to a third preferred embodiment of the present invention.

FIG. 29 is a second perspective view of the coil antenna according to the third preferred embodiment of the present invention.

FIG. 30 is a plan view of the coil antenna according to the third preferred embodiment of the present invention.

FIG. 31 is a first perspective view of a first variation of the coil antenna according to the third preferred embodiment of the present invention.

FIG. 32 is a second perspective view of the first variation of the coil antenna according to the third preferred embodiment of the present invention.

FIG. 33 is a first perspective view of a second variation of the coil antenna according to the third preferred embodiment of the present invention.

FIG. 34 is a second perspective view of the second variation of the coil antenna according to the third preferred embodiment of the present invention.

FIG. 35 is a first perspective view of a third variation of the coil antenna according to the third preferred embodiment of the present invention.

FIG. 36 is a second perspective view of the third variation of the coil antenna according to the third preferred embodiment of the present invention.

FIG. 37 is a first perspective view of a fourth variation of the coil antenna according to the third preferred embodiment of the present invention.

FIG. 38 is a second perspective view of the fourth variation of the coil antenna according to the third preferred embodiment of the present invention.

FIG. 39 is a first perspective view of a coil antenna according to a fourth preferred embodiment of the present invention.

FIG. 40 is a second perspective view of the coil antenna according to the fourth preferred embodiment of the present invention.

FIG. 41 is a plan view of the coil antenna according to the fourth preferred embodiment of the present invention.

FIG. 42 is a first perspective view of a first variation of the coil antenna according to the fourth preferred embodiment of the present invention.

FIG. 43 is a second perspective view of the first variation of the coil antenna according to the fourth preferred embodiment of the present invention.

FIG. 44 is a first perspective view of a second variation of the coil antenna according to the fourth preferred embodiment of the present invention.

FIG. 45 is a second perspective view of the second variation of the coil antenna according to the fourth preferred embodiment of the present invention.

FIG. 46 is a first perspective view of a third variation of the coil antenna according to the fourth preferred embodiment of the present invention.

FIG. 47 is a second perspective view of the third variation of the coil antenna according to the fourth preferred embodiment of the present invention.

FIG. 48 is a first perspective view of a coil antenna according to a fifth preferred embodiment of the present invention.

FIG. 49 is a second perspective view of the coil antenna according to the fifth preferred embodiment of the present invention.

FIG. 50 is a plan view of the coil antenna according to the fifth preferred embodiment of the present invention.

FIG. 51 is a first perspective view of a variation of the coil antenna according to the fifth preferred embodiment of the present invention.

FIG. 52 is a second perspective view of the variation of the coil antenna according to the fifth preferred embodiment of the present invention.

FIG. 53 is a first perspective view of a coil antenna according to a sixth preferred embodiment of the present invention.

FIG. 54 is a second perspective view of the coil antenna according to the sixth preferred embodiment of the present invention.

FIG. 55 is a plan view of the coil antenna according to the sixth preferred embodiment of the present invention.

FIG. 56 is a first perspective view of a first variation of the coil antenna according to the sixth preferred embodiment of the present invention.

FIG. 57 is a second perspective view of the first variation of the coil antenna according to the sixth preferred embodiment of the present invention.

FIG. 58 is a first perspective view of a second variation of the coil antenna according to the sixth preferred embodiment of the present invention.

FIG. 59 is a second perspective view of the second variation on the coil antenna according to the sixth preferred embodiment of the present invention.

FIG. 60 is a first perspective view of a coil antenna according to a seventh preferred embodiment of the present invention.

FIG. 61 is a second perspective view of the coil antenna according to the seventh preferred embodiment of the present invention.

FIG. 62 is a plan view of the coil antenna according to the seventh preferred embodiment of the present invention.

FIG. 63 is a perspective view of a variation of the coil antenna according to the seventh preferred embodiment of the present invention.

FIG. 64 is a first perspective view of a coil antenna according to an eighth preferred embodiment of the present invention.

FIG. 65 is a second perspective view of the coil antenna according to the eighth preferred embodiment of the present invention.

FIG. 66 is a plan view of the coil antenna according to the eighth preferred embodiment of the present invention.

FIG. 67 is a perspective view of a variation of the coil antenna according to the eighth preferred embodiment of the present invention.

FIG. 68 is a plan view of a first example of a band shape of a conductor pattern in a coil antenna according to a preferred embodiment of the present invention.

FIG. 69 is a plan view of a second example of the band shape of the conductor pattern in a coil antenna according to a preferred embodiment of the present invention.

FIG. 70 is a plan view of a third example of the band shape of the conductor pattern in a coil antenna according to a preferred embodiment of the present invention.

FIG. 71 is a descriptive view for explaining outer dimensions of a multilayer body in a coil antenna according to a preferred embodiment of the present invention.

FIG. 72 is a conceptual view illustrating a first example of a relationship between a lamination direction of the multilayer body and a winding axis of a coil conductor.

FIG. 73 is a conceptual view illustrating a second example of the relationship between the lamination direction of the multilayer body and the winding axis of the coil conductor.

FIG. 74 is a conceptual view illustrating a third example of the relationship between the lamination direction of the multilayer body and the winding axis of the coil conductor.

FIG. 75 is a side view of a coil-mounted substrate according to a ninth preferred embodiment of the present invention.

FIG. 76 is a plan view of a recording medium according to a tenth preferred embodiment of the present invention.

FIG. 77 is a cross-sectional view of the recording medium according to the tenth preferred embodiment of the present invention.

FIG. 78 is a see-through plan view of the recording medium according to the tenth preferred embodiment of the present invention.

FIG. 79 is conceptual view of an electronic apparatus according to an eleventh preferred embodiment of the present invention.

FIG. 80 is conceptual view of an electronic apparatus according to a twelfth preferred embodiment of the present invention.

### DETAILED DESCRIPTION OF THE PREFERRED EMBODIMENTS

Dimension ratios in the drawings do not necessarily truly represent actual dimension ratios and are exaggerated to facilitate explanation in some cases. In the following desorption, when a concept of an upper or lower side is referred to, it indicates not an absolute upper or lower side but a relative upper or lower side in an illustrated posture.

When a concept of a right or left side is referred, it indicates a relative right or left side in the drawing that has been focused just before.

In the present specification, even a conductor that is referred to as an “electrode” is not limited an electrical connection. Even a conductor that does not provide an electrical connection and is provided in a similar manner to an electrode is referred to as “electrode” in some cases. For example, a “dummy electrode” is a conductor that does not provide an electrical connection.

### First Preferred Embodiment

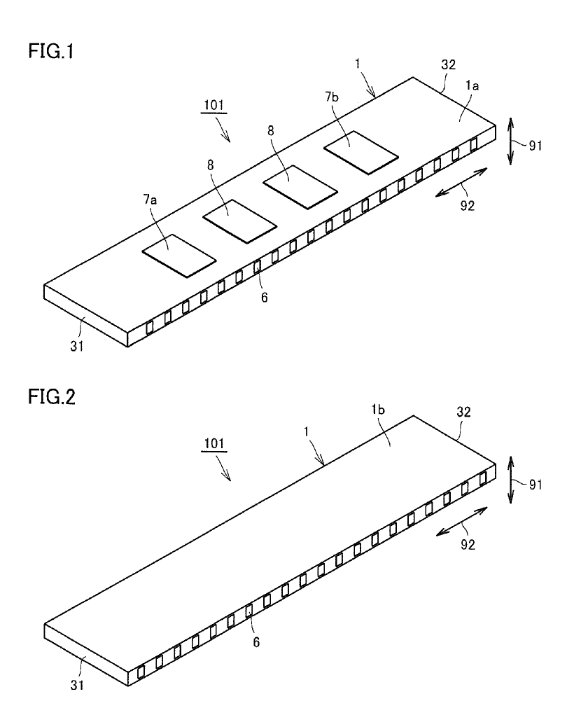

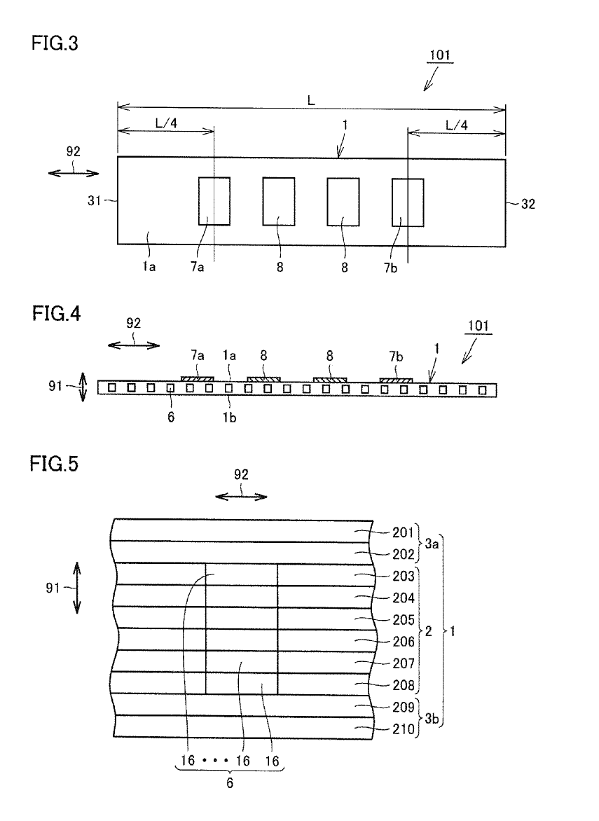

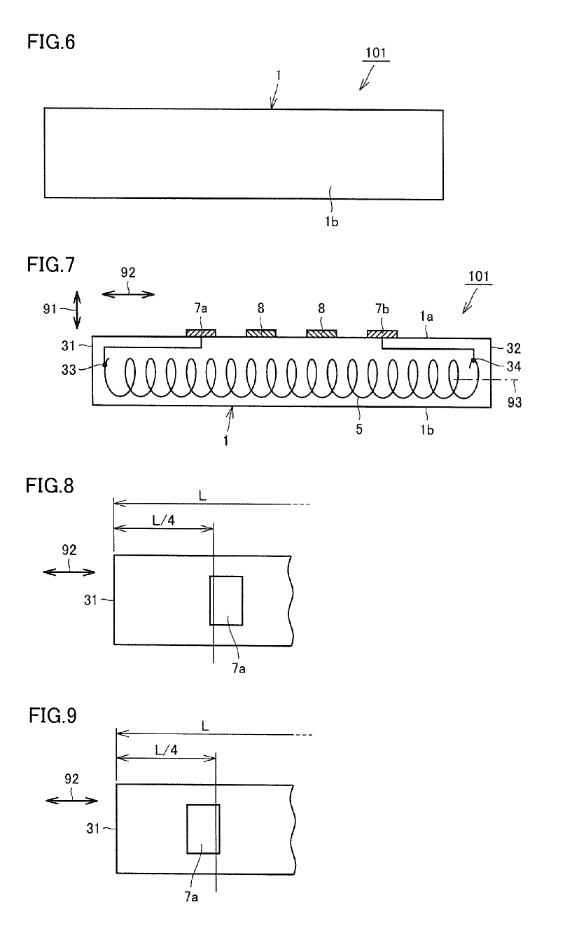

A coil antenna according to a first preferred embodiment of the present invention will be described with reference to FIG. 1 to FIG. 14. FIG. 1 is a perspective view when seen from a direction in which a first main surface 1a of a coil antenna 101 according to the present preferred embodiment is viewed. FIG. 2 is a perspective view in a turned-over state thereof. In FIG. 2, a second main surface 1b of the coil antenna 101 is viewed. The first main surface 1a and the second main surface 1b have a front-rear relationship. FIG. 3 is a plan view when the side of the first main surface 1a of the coil antenna 101 is the upper side. The coil antenna 101 preferably has a rectangular or substantially rectangular shape when seen from above as illustrated in FIG. 3. FIG. 4 is a side view when the side surface thereof along a long side is seen. In FIG. 4, a state in which a plurality of interlayer connection conductor assemblies 6 are exposed at the side surfaces is seen. FIG. 5 illustrates the vicinity of one of the interlayer connection conductor assemblies 6 in an enlarged manner. The interlayer connection conductor assembly 6 includes a plurality of interlayer connection conductors 16 that are continuous in the thickness direction. As illustrated in FIG. 5, a multilayer body 1 includes a magnetic layer 2 and non-magnetic layers 3a and 3b sandwiching the magnetic layer 2 therebetween from the upper and lower sides. The magnetic layer 2 is preferably defined by, for example, a sintered body of magnetic ceramic. Magnetic ferrite or other suitable material is used for the magnetic layer 2. The non-magnetic layers 3a and 3b are preferably defined by, for example, sintered bodies of non-magnetic ceramic. Non-magnetic ferrite or other suitable material is used for the non-magnetic layers 3a and 3b. The one magnetic layer 2 may include a plurality of layers that are laminated. The same holds true for each of the non-magnetic layers 3a and 3b. Here, the “non-magnetic layer” indicates a layer with lower magnetic permeability than the magnetic layer. The non-magnetic layer is not limited to a non-magnetic material. It is sufficient that the non-magnetic layer has lower magnetic permeability than the magnetic layer, and the non-magnetic layer may be made of a magnetic material as long as it satisfies this condition. FIG. 6 is a bottom view of the coil antenna 101. In this example, as illustrated in FIG. 6, no electrode is provided on the lower surface, that is, the second main surface 1b. FIG. 7 schematically illustrates a connection relationship of conductive bodies included in the coil antenna 101.

The coil antenna 101 according to the present preferred embodiment includes the multilayer body 1 (see FIG. 5) including the first main surface 1a which faces an outer side portion and is perpendicular or substantially perpendicular to a lamination direction 91 and the magnetic layer 2, a coil conductor 5 (see FIG. 7) defined by conductive bodies provided in the multilayer body 1 or on the surface thereof with the magnetic layer 2 defining a core, a first terminal 7a provided on the first main surface 1a and being electrically connected to the coil conductor 5, and a second terminal 7b provided on the first main surface 1a and being electrically connected to the coil conductor 5. The multilayer body 1 includes an insulating layer. The magnetic layer 2 is one type of the insulating layer. The core of the coil conductor 5 is at least a portion of the multilayer body 1. As illustrated in FIG. 3, the first terminal 7a covers at least a portion of a point at an L/4 position from one end 31 of the first main surface 1a in a lengthwise direction 92 when the length of the first main surface 1a in the lengthwise direction 92 is L. The second terminal 7b covers at least a portion of a point at an L/4 position from the other end 32 of the first main surface 1a in the lengthwise direction 92.

The expression “the first terminal 7a covers at least a portion of the point at the L/4 position from the one end 31 of the first main surface 1a in the lengthwise direction 92” enables the first terminal 7a to be in a state as illustrated in FIG. 8 or FIG. 9. That is to say, it is sufficient that even an extremely small portion of the first terminal 7a overlaps with a virtual vertical line indicating the L/4 position from the one end 31.

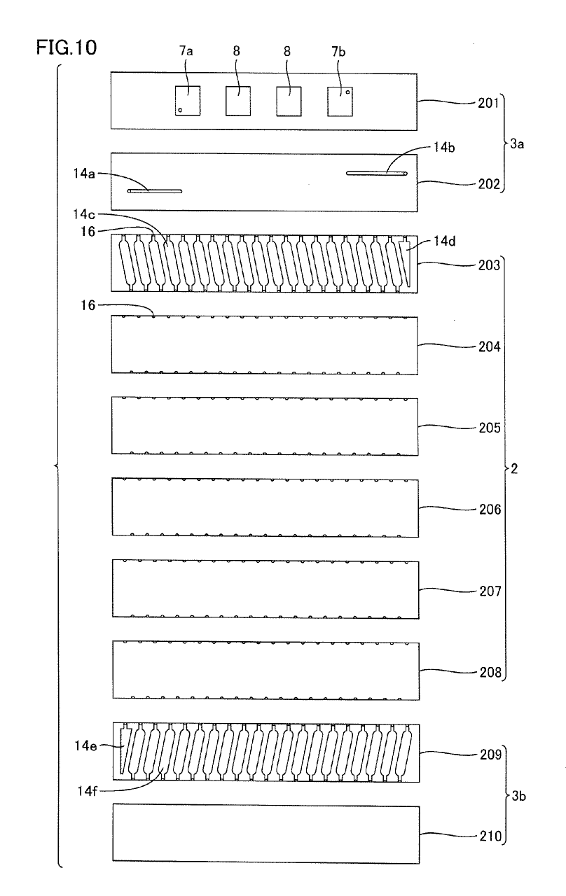

FIG. 10 is a view in which plan views of the respective layers included in the multilayer body 1 of the coil antenna 101 are aligned in the laminated order for display, that is, a lamination view. In FIG. 10, positions at which the interlayer connection conductors are provided are indicated by small circles or semicircles.

In the present preferred embodiment, the coil antenna 101 includes ten layers 201, 202, 203, 204, 205, 206, 207, 208, 209, and 210. The multilayer body 1 is formed by laminating the ten layers. The total thickness of the ten laminated layers is preferably, for example, approximately 300 μm. As illustrated in FIG. 5, the respective layers 203, 204, 205, 206, 207, and 208 are the magnetic layers. A combined portion of the layers 203, 204, 205, 206, 207, and 208 is the magnetic layer 2. Each of the layers 203, 204, 205, 206, 207, and 208 includes the interlayer connection conductors 16. The multilayer body 1 includes the magnetic layer.

The layers 201, 202, 209, and 210 are the non-magnetic layers. A combined portion of the layers 201 and 202 is the non-magnetic layer 3a. A combined portion of the layers 209 and 210 is the non-magnetic layer 3b. The magnetic layer 2 is interposed between the non-magnetic layers 3a and 3b.

As illustrated in FIG. 10, the first terminal 7a, the second terminal 7b, and two dummy electrodes 8 are provided on the surface of the layer 201. Lengthwise-shaped conductor patterns 14a and 14b are provided on the surface of the layer 202. The conductor patterns 14a and 14b are provided in parallel or substantially in parallel with the long sides of the layer 202. A plurality of elliptical or substantially elliptical conductor patterns 14c are provided on the surface of the layer 203. The plurality of conductor patterns 14c are aligned in parallel or substantially in parallel. The semicircular interlayer connection conductors 16 are provided at both ends of each of the conductor patterns 14c. A triangular or substantially triangular conductor pattern 14d is provided at one end of the layer 203. No conductor pattern is provided on the layers 204 to 208 but the plurality of semicircular interlayer connection conductors 16 are provided thereon along the two opposing long sides.

A plurality of conductor patterns 14f and one conductor pattern 14e are provided on the layer 209. A layout of the conductor patterns provided on the surface of the layer 209 is the same or substantially the same as a layout obtained by rotating the layout of the layer 203 by 180 degrees. Neither of the conductor pattern nor the interlayer connection conductor is provided on the layer 210.

The conductor patterns on the surfaces of the respective layers may preferably be formed by, for example, printing. The layers including the interlayer connection conductors 16 along the long sides among the layers 201 to 210 may preferably be manufactured by a method illustrated in FIG. 11 to FIG. 14.

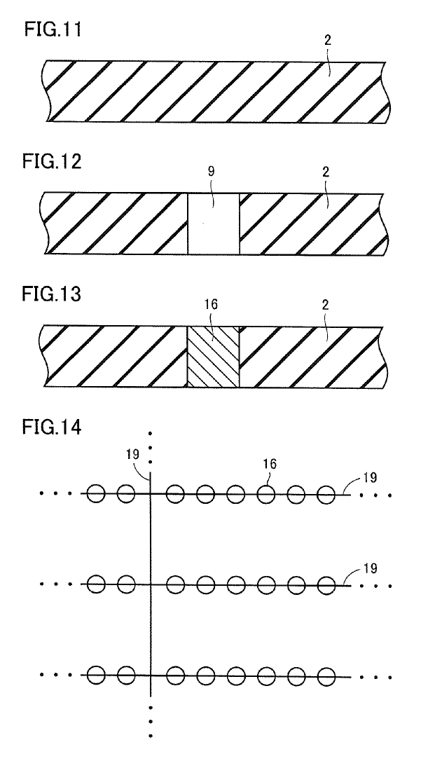

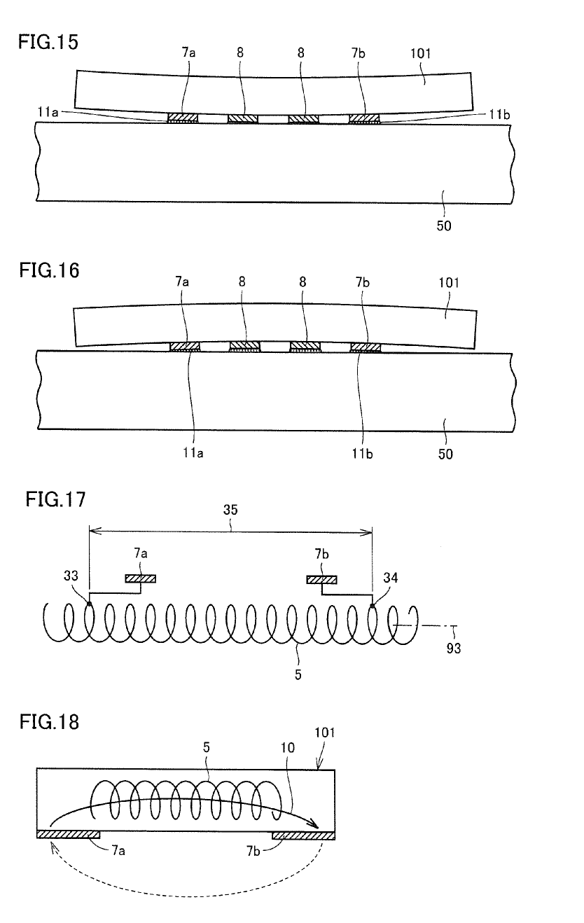

First, the magnetic layer 2 is prepared, as illustrated in FIG. 11. As illustrated in FIG. 12, via holes 9 are formed by laser processing or other suitable method. The via holes 9 are formed so as to penetrate through the magnetic layer 2. The via holes 9 are filled with conductive pastes. In this manner, the interlayer connection conductors 16 are formed as illustrated in FIG. 13. At this time point, the interlayer connection conductors 16 are lumps of the conductive pastes preferably having cylindrical or substantially cylindrical shapes, or truncated cone or substantially truncated cone shapes, for example. As illustrated in a plan view in FIG. 14, the interlayer connection conductors 16 are linearly aligned. Cutting lines 19 pass through the aligned interlayer connection conductors 16. A large-sized sheet is able to be divided into layers each having a size corresponding to an individual coil antenna by being cut along the cutting lines 19. This cutting operation is also referred to as individualization. The respective layers are formed in this manner, so that the semicircular interlayer connection conductors 16 are aligned along the long sides.

In the present preferred embodiment, the coil antenna 101 is obtained by laminating the ten layers 201 to 210 in this order, individualizing the lamination, and then, baking the individualized ones. The coil antenna 101 includes the ten layers in total herein but it is merely an example and the number of layers is not limited to ten. The number of layers defining the coil antenna may be a number other than ten. The number of magnetic layers and the number of non-magnetic layers included in one coil antenna may be a number other than the numbers in the present preferred embodiment.

A structure of a conductive body portion included in the coil antenna 101 according to the present preferred embodiment will be described with reference to FIG. 7 and FIG. 10. The conductor patterns provided on the surfaces of the layers 203 and 209 and the interlayer connection conductors 16 provided on the layers 203 to 208 are continuous to each other, so that the coil conductor 5 is provided. The coil antenna 101 having a winding axis (also referred to as a “coil axis”) 93 along the direction perpendicular or substantially perpendicular to the lamination direction of the layers 201 to 210 is provided. The winding axis 93 is in parallel or substantially in parallel with the lengthwise direction (the same direction as the lengthwise direction 92 of the first main surface 1a) of the multilayer body 1. FIG. 7 schematically illustrates the coil conductor 5. As illustrated in FIG. 7, the first terminal 7a is connected to the coil conductor 5 at a first connection point 33 in the vicinity of one end of the coil conductor 5. The second terminal 7b is connected to the coil conductor 5 at a second connection point 34 in the vicinity of the other end of the coil conductor 5.

The coil antenna 101 according to the present preferred embodiment is structured such that the first terminal 7a and the second terminal 7b which are electrically connected to the coil conductor 5 respectively cover at least portions of the points at the L/4 positions from the ends. That is to say, the first terminal 7a and the second terminal 7b are not disposed only at positions that are extremely close to the ends as in the existing technique but arranged so as to be close to the center to some extent. Therefore, even if the coil antenna 101 is warped when mounted on a substrate 50 as illustrated in FIG. 15, the first terminal 7a and the second terminal 7b necessary for electrical connection are prevented from significantly floating up from the surface of the substrate 50, thus appropriately connecting them with solders 11a and 11b. In this case, the dummy electrodes 8 may be or may not be soldered. When the dummy electrodes 8 are soldered with the substrate 50 side, mounting of the coil antenna 101 is more stable. Furthermore, when force in the direction of separating the coil antenna 101 from the substrate 50 is applied, concentration of stress on only the first terminal 7a and the second terminal 7b is avoided, thus increasing connection strength.

As illustrated in FIG. 16, even when the coil antenna 101 is warped in the opposite direction, the present preferred embodiment prevents the first terminal 7a and the second terminal 7b necessary for the electrical connection from significantly floating up from the surface of the substrate 50, thus appropriately connecting them with the solders 11a and 11b.

As described above, the coil antenna according to the present preferred embodiment enables reliable connection of the electrodes when the coil antenna is mounted on the substrate even if warpage is generated.

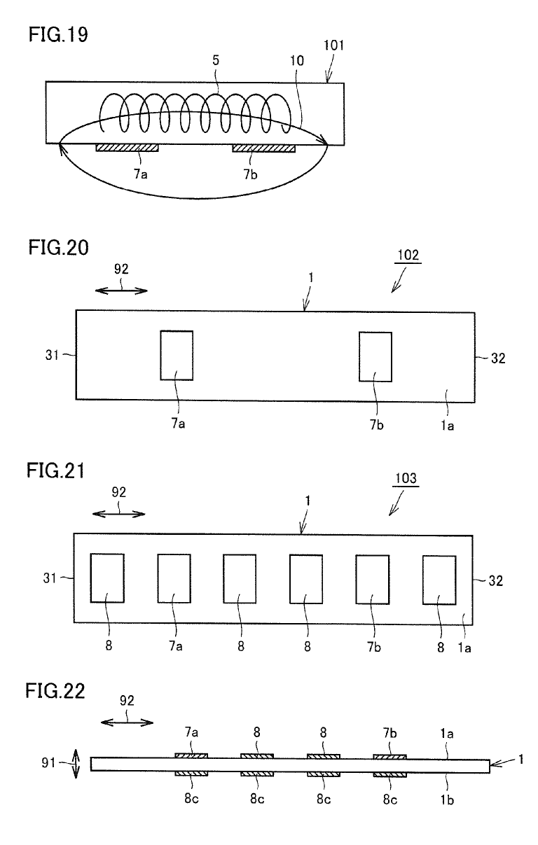

As described in the present preferred embodiment with reference to FIG. 7, preferably, the first terminal 7a is electrically connected to the first connection point 33 of the coil conductor 5, the second terminal 7b is electrically connected to the second connection point 34 of the coil conductor 5, and the first terminal 7a and the second 7b are disposed so as to be located between the first connection point 33 and the second connection point 34 when the multilayer body 1 is seen from the lamination direction 91. In FIG. 7, the first connection point 33 and the second connection point 34 are provided at positions close to the ends of the coil conductor 5 and portions through which no current flows are small. However, even when the first connection point 33 and the second connection point 34 are located at positions farther from the ends of the coil conductor 5 to some extents as illustrated in FIG. 17, for example, the first terminal 7a and the second terminal 7b are preferably located between the first connection point 33 and the second connection point 34, that is, in a range 35. When current flows through the coil conductor 5, a magnetic flux is generated from a portion in which the current actually flows. However, when the positions of the first terminal 7a and the second terminal 7b do not satisfy the above-described condition, there is the risk that a magnetic flux 10 spreading to an outer side portion of the coil antenna 101 is blocked by either of the first terminal 7a or the second terminal 7b or both of them, as illustrated in FIG. 18. On the other hand, when the positions of the first terminal 7a and the second terminal 7b satisfy the above-described condition, the magnetic flux 10 is able to sufficiently spread to the outer side portion of the coil antenna 101 because the first terminal 7a and the second terminal 7b do not block the magnetic flux 10, as illustrated in FIG. 19. A coupling coefficient is therefore increased. Furthermore, a magnetic flux that does not spread to the outer side portion of the coil antenna 101 and follows a narrow path is preferably blocked by the first terminal 7a and the second terminal 7b. The magnetic flux that does not spread to the outer side portion of the coil antenna 101 is blocked by the first terminal 7a and the second terminal 7b, thus contributing to the increase in the coupling coefficient.

A coil antenna 102 having a configuration illustrated in FIG. 20 may also be provided. That is to say, the configuration in which only the first terminal 7a and the second terminal 7b are provided on the first main surface 1a and no dummy electrode 8 is provided may be used.

As in the coil antenna 101 according to the first preferred embodiment, it is preferable that, in addition to the first terminal 7a and the second terminal 7b, at least one first main surface dummy electrodes be provided on the first main surface 1a. In the first preferred embodiment, the dummy electrodes 8 (see FIG. 3) correspond to the first main surface dummy electrodes. Providing the first main surface dummy electrodes in this manner increases the bonding strength when the coil antenna is mounted on the substrate and provides a more stable mounting state as described above. For example, as in a coil antenna 103 illustrated in FIG. 21, a configuration in which the first terminal 7a and the second terminal 7b are provided on the first main surface 1a, the dummy electrodes 8 are further provided between the first terminal 7a and the second terminal 7b, and the dummy electrode 8 is also provided at each of the end 31 side relative to the first terminal 7a and the end 32 side relative to the second terminal 7b may preferably be used.

As described in the first preferred embodiment, it is preferable that the at least one first main surface dummy electrode, that is, the dummy electrodes 8 be provided at only the positions interposed between the first terminal 7a and the second terminal 7b. When the coil antenna 101 is mounted on the substrate, it is not preferable that wirings arranged on the surface of the substrate make contact with the dummy electrodes. When the dummy electrodes 8 are provided at the positions interposed between the first terminal 7a and the second terminal 7b, both of a wiring which is drawn out from the first terminal 7a and a wiring which is drawn out from the second terminal 7b are easily drawn out to the outer side portion without making contact with the dummy electrodes 8.

As illustrated in FIG. 22, it is preferable that the multilayer body 1 include a second main surface 1b facing an opposite side to the first main surface 1a and electrodes be provided on the second main surface 1b in a mirror-image symmetrical manner with the electrodes provided on the first main surface 1a. In the example illustrated in FIG. 22, the electrodes provided on the first main surface 1a are the first terminal 7a, the second terminal 7b, and the two dummy electrodes 8. Accordingly, second main surface dummy electrodes 8c are preferably provided on the second main surface 1b in the mirror-image symmetrical manner with a set of these electrodes. FIG. 22 is a side view but alignment of the electrodes when the multilayer body 1 is seen from above and alignment of the electrodes when it is seen from the bottom are the same and have a mirror-image relationship. With this configuration, conditions related to the presence and absence of the electrodes are the same or substantially the same between the upper surface and the lower surface, thus reducing warpage which is generated in the multilayer body 1 in the baking process or other processes.

As described in the first preferred embodiment, the coil conductor 5 preferably includes the interlayer connection conductors 16 arranged so as to be exposed at the side surfaces of the multilayer body 1 along the lamination direction of the multilayer body 1. The interlayer connection conductors 16 defining a portion of the coil conductor 5 are thus exposed at the side surfaces, so that a state in which no more magnetic material is present in lateral outer side portions of the coil conductor 5 is provided. This state increases the coupling coefficient. The interlayer connection conductors 16 are preferably exposed at the side surfaces of the multilayer body 1 in the above-described manner but this is not essential. The interlayer connection conductors 16 may be provided in the multilayer body 1.

As described in the first preferred embodiment, the multilayer body 1 preferably includes the magnetic layer 2 in a region in which the coil conductor 5 is provided and includes the non-magnetic layer at at least one side of the upper side and the lower side relative to the coil conductor 5 when the multilayer body 1 is seen such that the lamination direction 91 is an up-down direction. In the preferable example illustrated in FIG. 5, the multilayer body 1 includes the non-magnetic layers 3a and 3b (see FIG. 5) on both of the upper side and the lower side relative to the coil conductor 5, respectively. This configuration provides a state in which no magnetic material is present in outer side portions of the coil conductor 5 in the up-down direction, thus increasing the coupling coefficient in the coil antenna.

In the first preferred embodiment, preferably, a portion surrounded by the coil conductor 5 may be defined by the magnetic layers, layers located in the outer side portions of the coil conductor 5, that is, some layers close to the uppermost surface and the lowermost surface are defined by the non-magnetic layers. Alternatively, all of the layers from the uppermost surface to the lowermost surface of the multilayer body may be defined by the magnetic layers. All of the layers from the uppermost surface to the lowermost surface of the multilayer body may be made of a ferromagnetic material, for example. When all of the layers of the multilayer body are defined by the magnetic layers, the coupling coefficient becomes small in comparison to the case in which some layers close to the uppermost surface and the lowermost surface are defined by the non-magnetic layers but constant effects of the coil antenna are able to be obtained.

In the first preferred embodiment, preferably, the portion surrounded by the coil conductor 5 is defined by the magnetic layers, the layers located in the outer side portions of the coil conductor 5, that is, some layers close to the uppermost surface and the lowermost surface are defined by the non-magnetic layers, as an example. Alternatively, all of the layers from the uppermost surface to the lowermost surface of the multilayer body may be defined by the non-magnetic layers. That is to say, all of the layers from the uppermost surface to the lowermost surface of the multilayer body may be defined by a non-magnetic material. When all of the layers of the multilayer body are defined by the non-magnetic layers, radiation of a magnetic flux becomes small in comparison to the case in which the portion surrounded by the coil conductor 5 is defined by the magnetic material but constant effects of the coil antenna are able to be obtained. In this case, problems, such as loss with the magnetic material, are eliminated.

It is sufficient that the respective layers of the multilayer body are insulating layers defined by insulators. Whether the respective layers of the multilayer body are defined by the magnetic layers or the non-magnetic layers may be appropriately changed.

### Second Preferred Embodiment

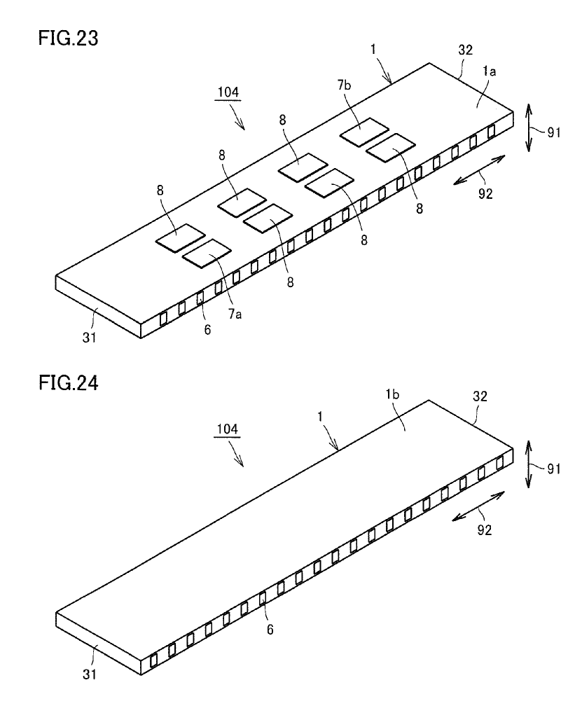

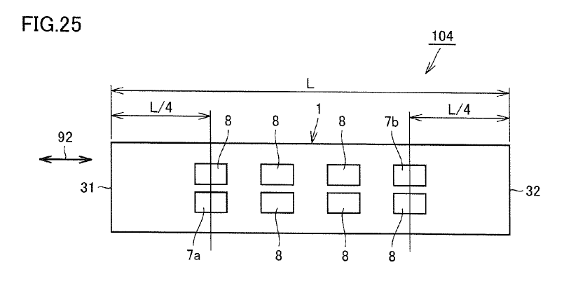

A coil antenna according to a second preferred embodiment of the present invention will be described with reference to FIG. 23 to FIG. 26. FIG. 23 is a perspective view when seen from a direction in which the first main surface 1a of a coil antenna 104 according to the present preferred embodiment is viewed. FIG. 24 is a perspective view in a turned-over state thereof. In FIG. 24, the second main surface 1b of the coil antenna 104 is viewed. The first main surface 1a and the second main surface 1b have a front-rear relationship. FIG. 25 is a plan view when the side of the first main surface 1a of the coil antenna 104 is seen from above. The coil antenna 104 preferably has a rectangular or substantially rectangular shape when seen from above as illustrated in FIG. 25. The basic configuration of the coil antenna 104 is common to that of the coil antenna 101 according to the first preferred embodiment. The coil antenna 104 is different from the coil antenna 101 in the configuration of electrodes on the first main surface 1a. In the coil antenna 104, the electrodes are aligned in two rows as illustrated in FIG. 23 and FIG. 25. Preferably, eight electrodes in total are provided on the first main surface 1a with alignment of 2×4, for example. As illustrated in FIG. 25, one lower left electrode of the eight electrodes is the first terminal 7a, one upper right electrode thereof is the second terminal 7b, and the other six electrodes are the dummy electrodes 8.

Also in the present preferred embodiment, the first terminal 7a is provided so as to cover at least a portion of a point at an L/4 position from one end of the first main surface 1a in the lengthwise direction 92 when the length of the first main surface 1a in the lengthwise direction 92 is L. The second terminal 7b is provided so as to cover at least a portion of a point at an L/4 position from the other end of the first main surface 1a in the lengthwise direction 92. This point is the same as that according to the first preferred embodiment.

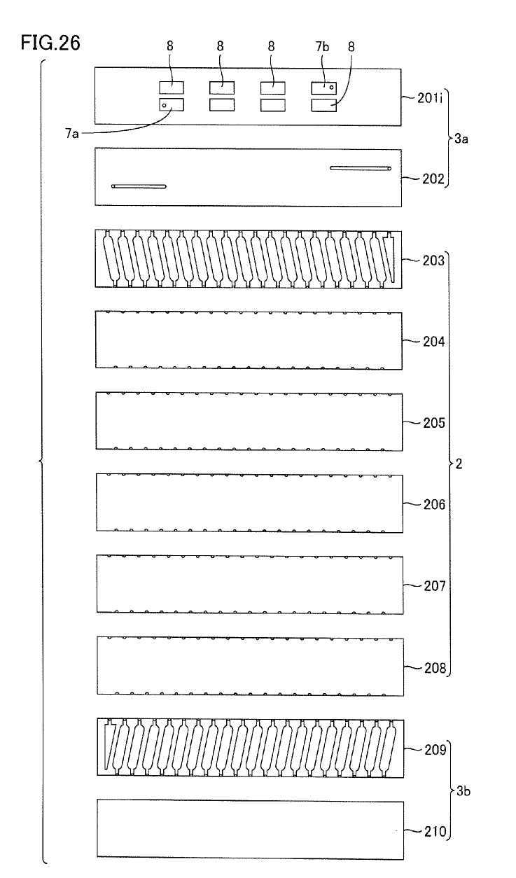

FIG. 26 is a view in which plan views of respective layers included in the multilayer body 1 of the coil antenna 104 are aligned, that is, FIG. 26 is a lamination view. The coil antenna 104 preferably includes ten layers 201i, and 202 to 210 in total, for example. This view is different from FIG. 10 in that a first layer from the top is replaced by the layer 201i.

Also in the present preferred embodiment, the same or substantially the same effects as those in the first preferred embodiment are obtained. In the present preferred embodiment, the electrodes are aligned in the two rows unlike the first preferred embodiment and the posture of the coil antenna is therefore more stable when it is mounted on a substrate or other structure.

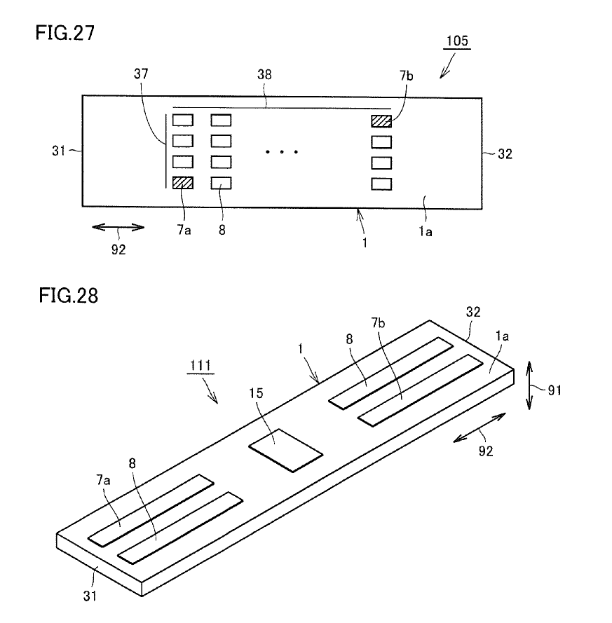

Although the electrodes are preferably aligned on the first main surface 1a in the two rows according to the second preferred embodiment, they are not limited to being aligned in the two rows and may be aligned in three or more rows. As illustrated in FIG. 27 as an example, it is preferable that a set of the first terminal 7a, the second terminal 7b, and the dummy electrodes 8 as the first main surface dummy electrodes be aligned on the first main surface 1a in a matrix defined by a first side 37 perpendicular or substantially perpendicular to the lengthwise direction 92 of the multilayer body 1 and a second side 38 in parallel or substantially in parallel with the lengthwise direction 92 of the multilayer body 1, and the number of electrodes aligned along the first side 37 be equal to or more than two. With this configuration, the posture of the coil antenna stable when the coil antenna is mounted on the substrate or other structure is more stable.

As described in the first and second preferred embodiments, the total number of the first terminal 7a, the second terminal 7b, and the dummy electrodes 8 as at least one first main surface dummy electrode provided on the first main surface 1a is preferably four or eight, for example. This configuration provides stable mounting without excessively increasing the number of electrodes.

### Third Preferred Embodiment

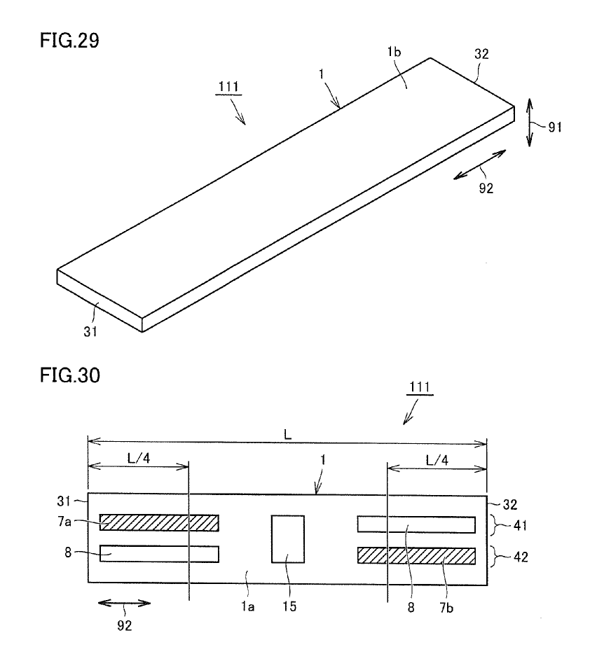

A coil antenna in a third preferred embodiment of the present invention will be described with reference to FIG. 28 to FIG. 30. FIG. 28 is a perspective view when seen from a direction in which the first main surface 1a of a coil antenna 111 according to the present preferred embodiment is viewed. FIG. 29 is a perspective view in a turned-over state thereof. In FIG. 29, the second main surface 1b of the coil antenna 111 is viewed. FIG. 30 is a plan view when the side of the first main surface 1a of the coil antenna 111 is seen from above. The basic configuration of the coil antenna 111 is common to that of the coil antenna 101 according to the first preferred embodiment. The coil antenna 111 is different from the coil antenna 101 in the configuration of an electrode group on the first main surface 1a.

In the coil antenna 111, each of the first terminal 7a and the second terminal 7b preferably has a band shape extending along the lengthwise direction of the first main surface 1a. The lengths of the first terminal 7a and the second terminal 7b along the lengthwise direction 92 of the first main surface are preferably equal or substantially equal to each other.

In the coil antenna 111, the electrode group includes two parallel or substantially parallel rows of a first row 41 and a second row 42, as illustrated in FIG. 30. Each of the first row 41 and the second row 42 extends in the lengthwise direction 92. The electrode group on the first main surface 1a may include an electrode that belongs to neither of the first row 41 nor the second row 42. In the example according to the present preferred embodiment, preferably, the electrode group on the first main surface 1a includes five electrodes in total of four band-shaped electrodes in total with alignment of 2×2 and one center conductor pattern 15 arranged at the center, for example. The first terminal 7a is a conductor pattern, the second terminal 7b is a conductor pattern, a set of all of the conductor patterns provided on the first main surface 1a includes the first row 41 and the second row 42 extending along the lengthwise direction 92 of the first main surface 1a, and the first row 41 and the second row 42 are aligned in the direction perpendicular or substantially perpendicular to the lengthwise direction 92 of the first main surface 1a. FIG. 30 illustrates the plurality of conductor patterns provided on the first main surface 1a, and the first terminal 7a and the second terminal 7b are hatched to facilitate description. As illustrated in FIG. 30, preferably, one upper left electrode of the four band-shaped electrodes is the first terminal 7a, one lower right electrode thereof is the second terminal 7b, and the other two electrodes are the dummy electrodes 8. In the coil antenna 111, the center conductor pattern 15 is disposed at the center or approximate center of the first main surface 1a, as illustrated in FIG. 30.

Also in the present preferred embodiment, as illustrated in FIG. 30, the first terminal 7a covers at least a portion of a point at an L/4 position from the one end 31 of the first main surface 1a in the lengthwise direction 92 when the length of the first main surface 1a in the lengthwise direction 92 is L. The first terminal 7a extends in the lengthwise direction 92 across the forward and backward sides of the L/4 position from the one end 31. The second terminal 7b covers at least a portion of a point at an L/4 position from the other end 32 of the first main surface 1a in the lengthwise direction 92. The second terminal 7b extends in the lengthwise direction 92 across the forward and backward sides of the L/4 position from the other end 32.

In the present preferred embodiment, each of the first terminal 7a and the second terminal 7b preferably has the band shape extending along the lengthwise direction 92, thus providing the coil antenna with resistances to warpage in the lengthwise direction 92 and heat impact.

The configuration of the first terminal 7a and the second terminal 7b as described in the present preferred embodiment is merely an example. In FIG. 30, for example, one lower left electrode may be the first terminal 7a and one upper right electrode may be the second terminal 7b. The one lower left electrode may be the first terminal 7a and the one lower right electrode may be the second terminal 7b. The one upper left electrode may be the first terminal 7a and the one upper right electrode may be the second terminal 7b. It is sufficient that any one of the electrodes at the left side is the first terminal 7a and any one of the electrodes at the right side is the second terminal 7b. As described in the present preferred embodiment, it is preferable that the first terminal 7a be in the first row 41 and the second terminal 7b be in the second row 42. This configuration enables the coil antenna to be used without taking the orientation thereof into consideration.

As described in the present preferred embodiment, preferably, the center conductor pattern 15 is provided at the center or approximate center of the first main surface 1a, and the first terminal 7a and the second terminal 7b are separated from the center conductor pattern 15 and sandwich the center conductor pattern 15 therebetween. This configuration enables impact to be dispersed to the coil antenna 111 overall through the center conductor pattern 15 at the time of dropping, thus improving the dropping strength thereof. The center conductor pattern 15 may be a dummy conductor pattern that does not provide an electrical connection.

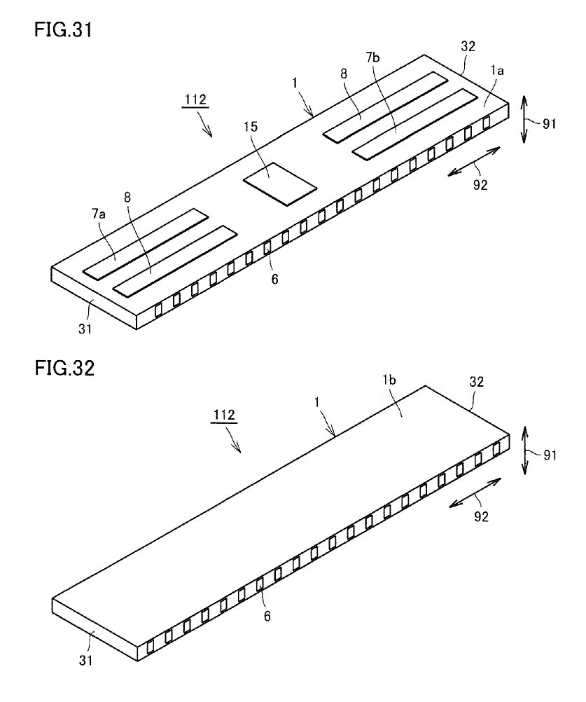

As a first variation of the coil antenna according to the third′ preferred embodiment, a coil antenna 112 illustrated in FIG. 31 and FIG. 32 may also be considered. FIG. 31 is a perspective view when seen from a direction in which the first main surface 1a of the coil antenna 112 is viewed and FIG. 32 is a perspective view in a turned-over state thereof. In the coil antenna 112, the plurality of interlayer connection conductor assemblies 6 are exposed at the side surfaces.

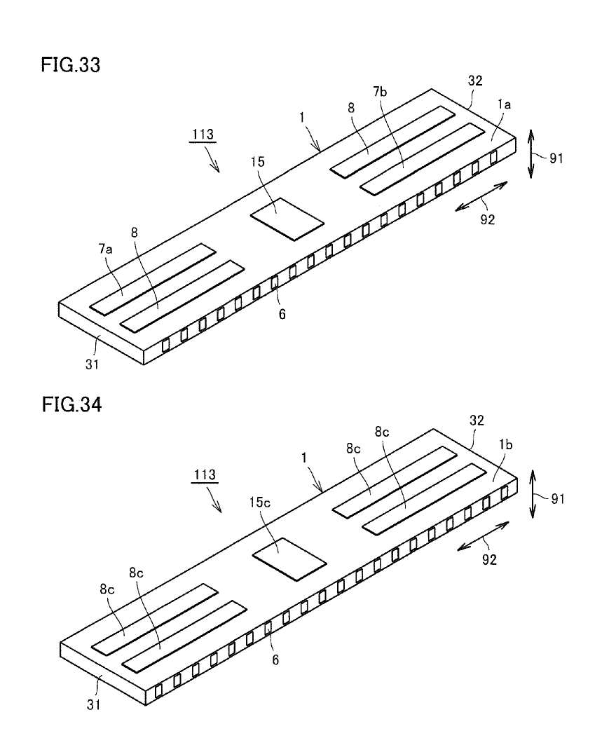

As a second variation of the coil antenna according to the third preferred embodiment, a coil antenna 113 illustrated in FIG. 33 and FIG. 34 may also be considered. FIG. 33 is a perspective view when seen from a direction in which the first main surface 1a of the coil antenna 113 is viewed and FIG. 34 is a perspective view in a turned-over state thereof. In the coil antenna 113, the plurality of interlayer connection conductor assemblies 6 are exposed at the side surfaces and electrodes are also provided on the second main surface 1b in a mirror-image symmetrical manner with the electrodes arranged on the first main surface 1a. Each of four band-shaped electrodes among the plurality of electrodes provided on the second main surface 1b is the second main surface dummy electrode 8c. A center conductor pattern 15c is provided at the center or approximate center of the second main surface 1b. The center conductor pattern 15c may be a dummy electrode.

Although the four band-shaped electrodes provided on the second main surface 1b are the second main surface dummy electrodes 8c in this example, these four band-shaped electrodes may have the same or substantially the same configurations as the four band-shaped electrodes on the first main surface 1a. For example, two electrodes of the four band-shaped electrodes arranged on the second main surface 1b may have the same functions as those of the first terminal 7a and the second terminal 7b. For this purpose, it is sufficient that the two selected electrodes on the second main surface 1b are electrically connected so as to respectively correspond to the first terminal 7a and the second terminal 7b on the first main surface 1a. With this configuration, the coil antenna is able to be mounted on a substrate or other structure in the same manner without taking the front and rear sides thereof into consideration when mounted on the substrate or other structure. In the following example, the same holds true for the case in which the second main surface dummy electrodes 8c are provided on the second main surface 1b.

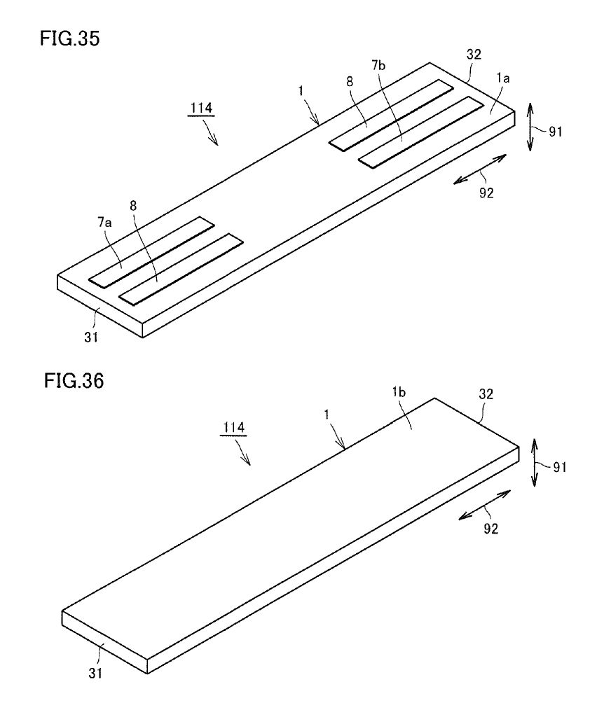

As a third variation of the coil antenna according to the third preferred embodiment, a coil antenna 114 illustrated in FIG. 35 and FIG. 36 may be considered. FIG. 35 is a perspective view when seen from a direction in which the first main surface 1a of the coil antenna 114 is viewed and FIG. 36 is a perspective view in a turned-over state thereof. In the coil antenna 114, no center conductor pattern 15 is provided, no interlayer connection conductor assembly 6 is provided on the side surfaces, and no electrode is provided on the second main surface 1b. This configuration may also be used.

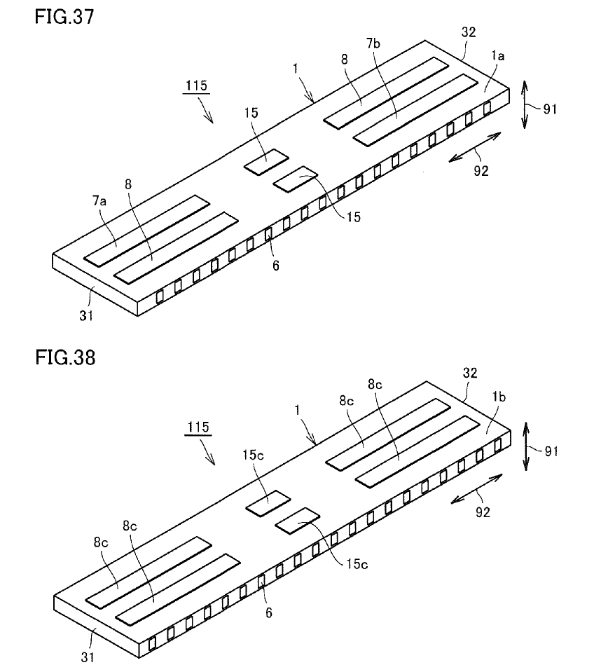

As a fourth variation of the coil antenna according to the third preferred embodiment, a coil antenna 115 illustrated in FIG. 37 and FIG. 38 may be considered. FIG. 37 is a perspective view when seen from a direction in which the first main surface 1a of the coil antenna 115 is viewed and FIG. 38 is a perspective view in a turned-over state thereof. The two center conductor patterns 15 are provided at the center or approximate center of the first main surface 1a. The two center conductor patterns 15 preferably have the same or substantially the same shape and are disposed in parallel or substantially in parallel with each other. The lengthwise direction of the center conductor patterns 15 is preferably in parallel or substantially in parallel with the lengthwise directions of the first terminal 7a, the second terminal 7b, and the dummy electrodes 8. The width of the center conductor patterns 15 is preferably equal or substantially equal to the widths of the first terminal 7a, the second terminal 7b, and the dummy electrodes 8.

In the coil antenna 115, the plurality of interlayer connection conductor assemblies 6 are exposed at the side surfaces. Electrodes are provided on the second main surface 1b of the coil antenna 115 in a mirror-image symmetrical manner with the electrodes arranged on the first main surface 1a. Each of four band-shaped electrodes among the plurality of electrodes provided on the second main surface 1b is the second main surface dummy electrode 8c. The two center conductor patterns 15c are provided at the center or approximate center of the second main surface 1b. The two center conductor patterns 15c may be dummy electrodes. These are merely examples and the configuration in which no interlayer connection conductor assembly 6 is provided on the side surfaces may also be used. The configuration in which no electrode is provided on the second main surface 1b may also be used.

Various variations of the coil antenna according to the third preferred embodiment may be considered as described above. For example, the plurality of interlayer connection conductor assemblies 6 may be or may not be provided on the side surfaces. For example, the center conductor pattern 15 may be or may not be provided on the first main surface 1a. For example, the center conductor pattern 15c may be or may not be provided on the second main surface 1b. Electrodes may be or may not be provided on the second main surface 1b in the mirror-image symmetrical manner with the electrodes arranged on the first main surface 1a. For example, the configuration in which some electrodes are provided on the first main surface 1a whereas no electrode is provided on the second main surface 1b may be used. For example, electrodes may be provided on the second main surface 1b with a configuration that is not mirror-image symmetrical with the electrodes arranged on the first main surface 1a. The possibilities of the various variations may be applied not only to the present preferred embodiment but to a fourth preferred embodiment and subsequent preferred embodiments described below.

### Fourth Preferred Embodiment

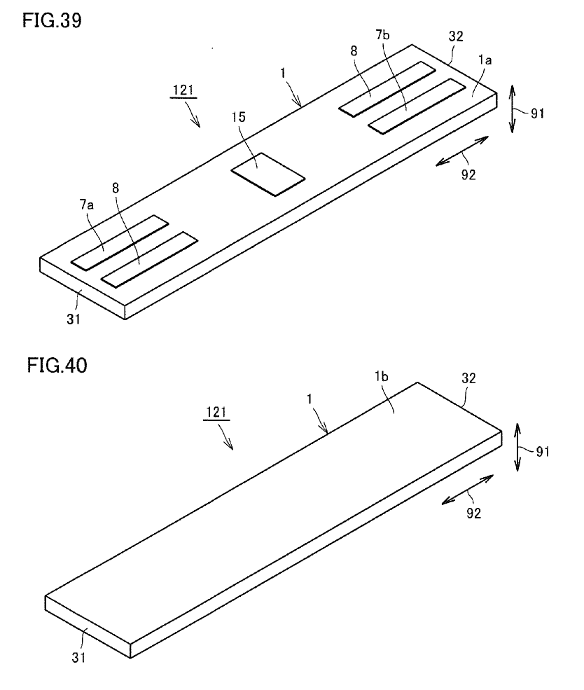

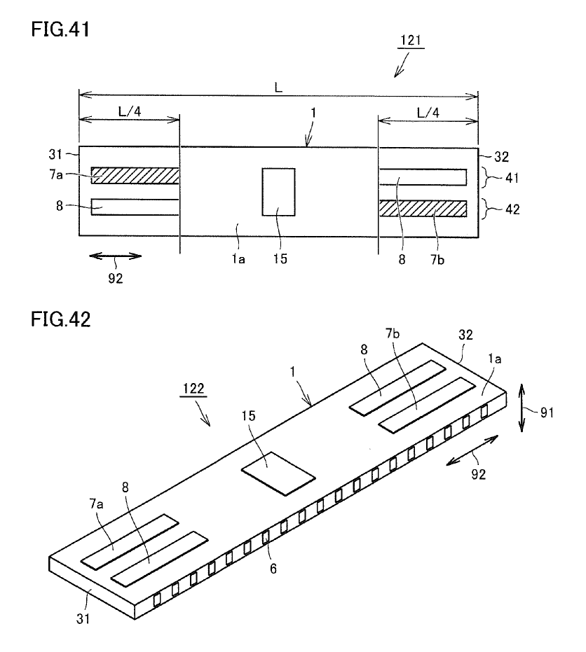

A coil antenna according to a fourth preferred embodiment of the present invention will be described with reference to FIG. 39 to FIG. 41. FIG. 39 is a perspective view when seen from a direction in which the first main surface 1a of a coil antenna 121 according to the present preferred embodiment is viewed. FIG. 40 is a perspective view in a turned-over state thereof. In FIG. 40, the second main surface 1b of the coil antenna 121 is viewed. FIG. 41 is a plan view when the side of the first main surface 1a of the coil antenna 121 is seen from above. The basic configuration of the coil antenna 121 is common to that of the coil antenna 111 according to the third preferred embodiment. The coil antenna 121 is different from the coil antenna 111 in the lengths of some electrodes on the first main surface 1a.

In the coil antenna 121, as illustrated in FIG. 41, the first terminal 7a covers at least a portion of a point at an L/4 position from the one end 31 of the first main surface 1a in the lengthwise direction 92 when the length of the first main surface 1a in the lengthwise direction 92 is L. The first terminal 7a extends in the lengthwise direction 92 so as to just reach the L/4 position from the one end 31. The second terminal 7b covers at least a portion of a point at an L/4 position from the other end 32 of the first main surface 1a in the lengthwise direction 92. The second terminal 7b extends in the lengthwise direction 92 so as to just reach the L/4 position from the other end 32. Also when the respective terminals just reach the L/4 positions from the ends in this manner, it is considered that the terminals cover at least portions of the points at the L/4 positions from the ends.

In the present preferred embodiment, each of the first terminal 7a and the second terminal 7b preferably has the band shape extending along the lengthwise direction 92, thus the coil antenna has resistances to warpage in the lengthwise direction 92 and heat impact. In the present preferred embodiment, the dimensions of the first terminal 7a and the second terminal 7b in the lengthwise direction 92 are preferably smaller than those in the coil antenna according to the third preferred embodiment. Due to the reduced dimensions, the coil antenna according to the present preferred embodiment is difficult to be influenced by thermal expansion, thus providing more excellent effects for the resistance to heat impact than those according to the third preferred embodiment. For the warpage in the lengthwise direction 92, the third preferred embodiment in which each of the first terminal 7a and the second terminal 7b is longer is more excellent but constant effects are also achieved in the present preferred embodiment.

The configuration of the first terminal 7a and the second terminal 7b, which is illustrated in FIG. 41, is merely an example. Also in the present preferred embodiment, it is sufficient that any one of the electrodes at the left side is the first terminal 7a and any one of the electrodes at the right side is the second terminal 7b as described in the third preferred embodiment.

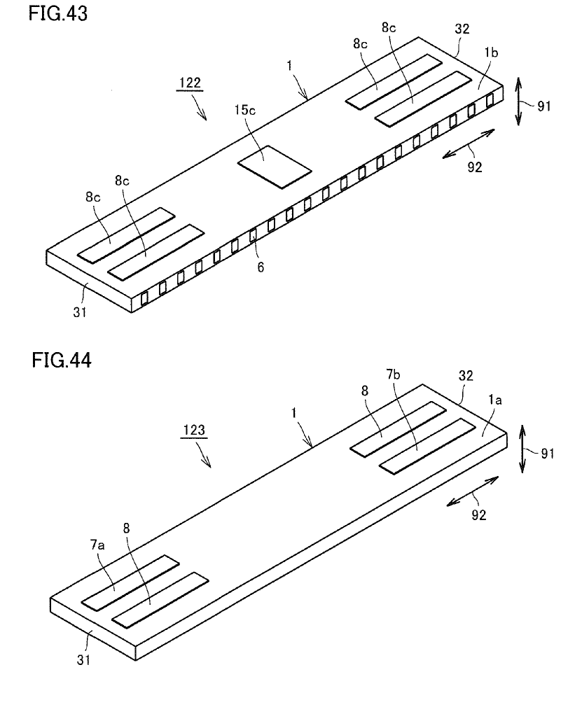

As a first variation of the coil antenna according to the fourth preferred embodiment, a coil antenna 122 illustrated in FIG. 42 and FIG. 43 may also be considered. FIG. 42 is a perspective view when seen from a direction in which the first main surface 1a of the coil antenna 122 is viewed and FIG. 43 is a perspective view in a turned-over state thereof. In the coil antenna 122, the plurality of interlayer connection conductor assemblies 6 are exposed at the side surfaces and electrodes are provided on the second main surface 1b in a mirror-image symmetrical manner with the electrodes arranged on the first main surface 1a. Each of four band-shaped electrodes among the plurality of electrodes provided on the second main surface 1b is the second main surface dummy electrode 8c. The center conductor pattern 15c is provided at the center or approximate center of the second main surface 1b.

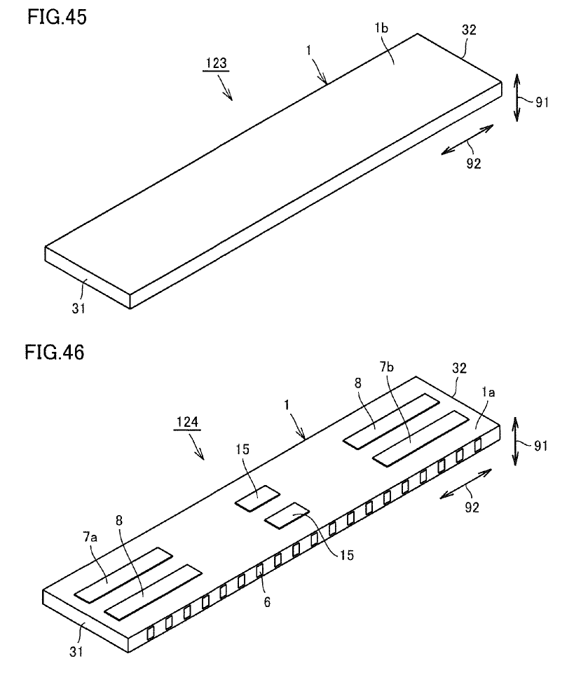

As a second variation on the coil antenna according to the present preferred embodiment, a coil antenna 123 illustrated in FIG. 44 and FIG. 45 may also be considered. FIG. 44 is a perspective view when seen from a direction in which the first main surface 1a of the coil antenna 123 is viewed and FIG. 45 is a perspective view in a turned-over state thereof. In the coil antenna 123, no center conductor pattern 15 is provided, no interlayer connection conductor assembly 6 is provided on the side surfaces, and no electrode is provided on the second main surface 1b.

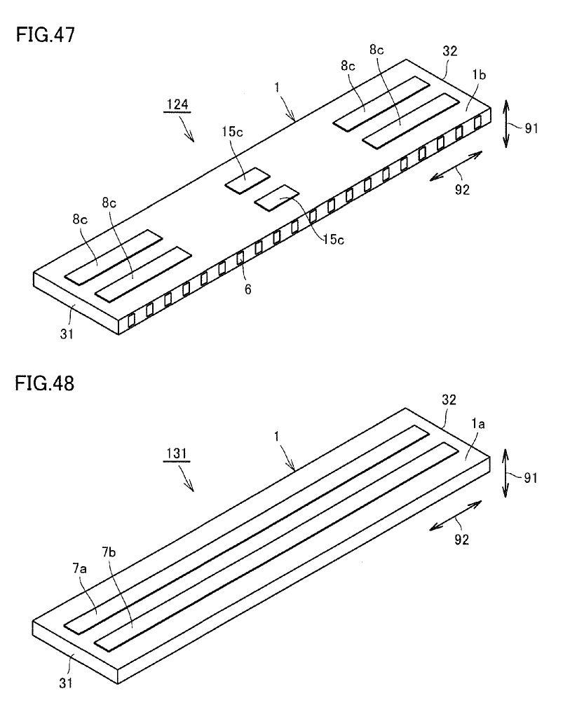

As a third variation on the coil antenna according to the present preferred embodiment, a coil antenna 124 shown in FIGS. 46 and 47 may also be considered. FIG. 46 is a perspective view when seen from a direction in which the first main surface 1a of the coil antenna 124 is viewed and FIG. 47 is a perspective view in a turned-over state thereof. The two center conductor patterns 15 are provided at the center or approximate center of the first main surface 1a. The two center conductor patterns 15 preferably have the same shape and are disposed in parallel or substantially in parallel with each other. The lengthwise direction of the center conductor patterns 15 is in parallel or substantially in parallel with the lengthwise directions of the first terminal 7a, the second terminal 7b, and the dummy electrodes 8. The width of the center conductor patterns 15 is preferably equal or substantially equal to the widths of the first terminal 7a, the second terminal 7b, and the dummy electrodes 8.

In the coil antenna 124, the plurality of interlayer connection conductor assemblies 6 are exposed at the side surfaces. Electrodes are provided on the second main surface 1b of the coil antenna 124 in a mirror-image symmetrical manner with the electrodes arranged on the first main surface 1a. Each of four band-shaped electrodes among the plurality of electrodes arranged on the second main surface 1b is the second main surface dummy electrode 8c. The two center conductor patterns 15c are provided at the center or approximate center of the second main surface 1b. The two center conductor patterns 15c may be dummy electrodes. These are merely examples and the configuration in which no interlayer connection conductor assembly 6 is provided on the side surfaces may also be used. The configuration in which no electrode is provided on the second main surface 1b may also be used.

### Fifth Preferred Embodiment

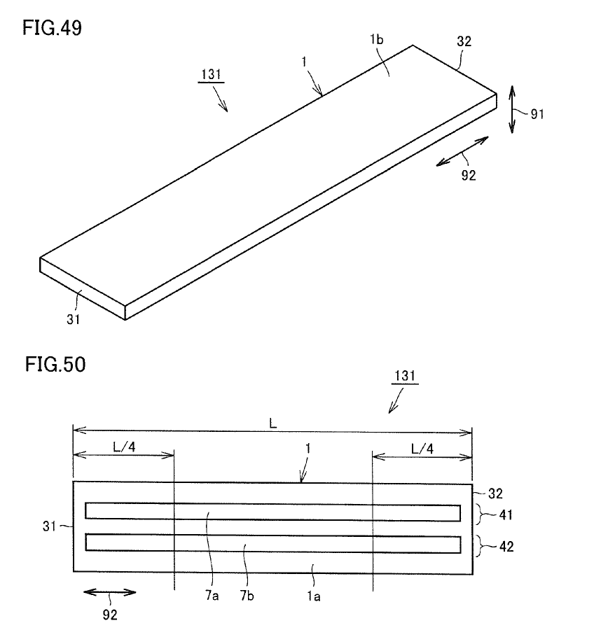

A coil antenna according to a fifth preferred embodiment of the present invention will be described with reference to FIG. 48 to FIG. 50. FIG. 48 is a perspective view when seen from a direction in which the first main surface 1a of a coil antenna 131 according to the present preferred embodiment is viewed. FIG. 49 is a perspective view in a turned-over state thereof. In FIG. 49, the second main surface 1b of the coil antenna 131 is viewed. FIG. 50 is a plan view when the side of the first main surface 1a of the coil antenna 131 is seen from above. The basic configuration of the coil antenna 131 is common to that of the coil antenna 111 in the third preferred embodiment. In the coil antenna 131, two band-shaped electrodes extend in the lengthwise direction 92 over the entire or substantially the entire length of the coil antenna 131 without discontinuity at the center portion, unlike the coil antenna 111. One of the two band-shaped electrodes is the first terminal 7a and the other thereof is the second terminal 7b. The coil antenna 131 includes no center conductor pattern. Preferably, the first terminal 7a belongs to the first row 41 and the second terminal 7b belongs to the second row 42 on the first main surface 1a of the coil antenna 131.

Also when the first terminal 7a and the second terminal 7b have the same or substantially the same length and are aligned in the direction perpendicular or substantially perpendicular to the lengthwise direction 92 as in the coil antenna 131 illustrated in FIG. 50, preferably, the first terminal 7a covers at least a portion of a point at an L/4 position from the one end 31 of the first main surface 1a in the lengthwise direction 92 when the length of the first main surface 1a in the lengthwise direction 92 is L. Further, the second terminal 7b covers at least a portion of a point at an L/4 position from the other end 32 of the first main surface 1a in the lengthwise direction 92.

In the present preferred embodiment, the first terminal 7a and the second terminal 7b are preferably extremely long, thus providing a coil antenna having high resistance to warpage in the lengthwise direction 92. When the coil antenna is mounted on another component, the coil antenna is mounted with the two band-shaped terminals interposed therebetween, thus making the posture thereof preferable and improving resistance to dropping impact. Resistance to deflection of the substrate is also improved.

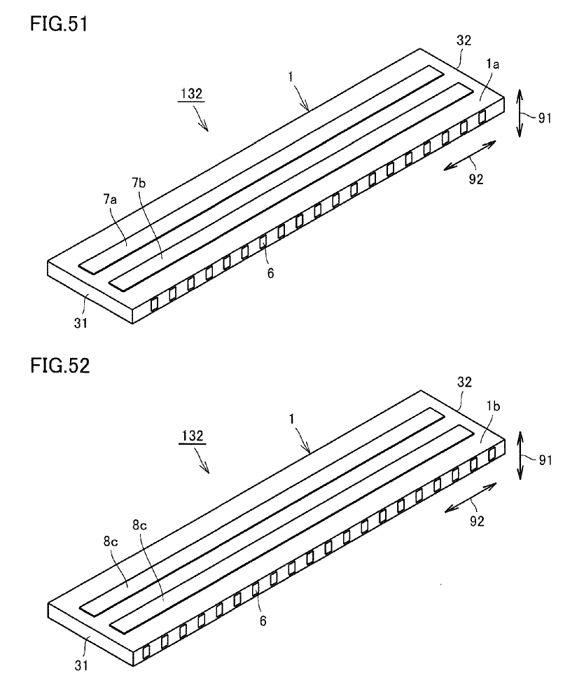

As a variation on the coil antenna according to the present preferred embodiment, a coil antenna 132 illustrated in FIG. 51 and FIG. 52 may also be considered. In the coil antenna 132, the plurality of interlayer connection conductor assemblies 6 are exposed at the side surfaces and electrodes are provided on the second main surface 1b in a mirror-image symmetrical manner with the electrodes arranged on the first main surface 1a.

### Sixth Preferred Embodiment

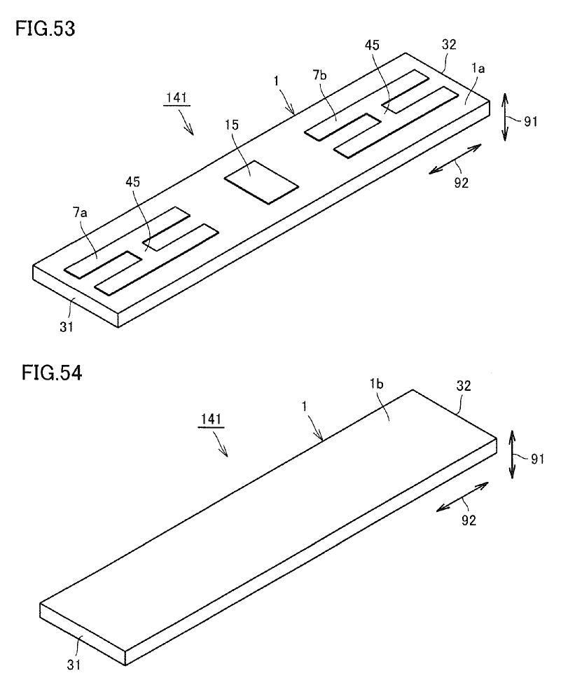

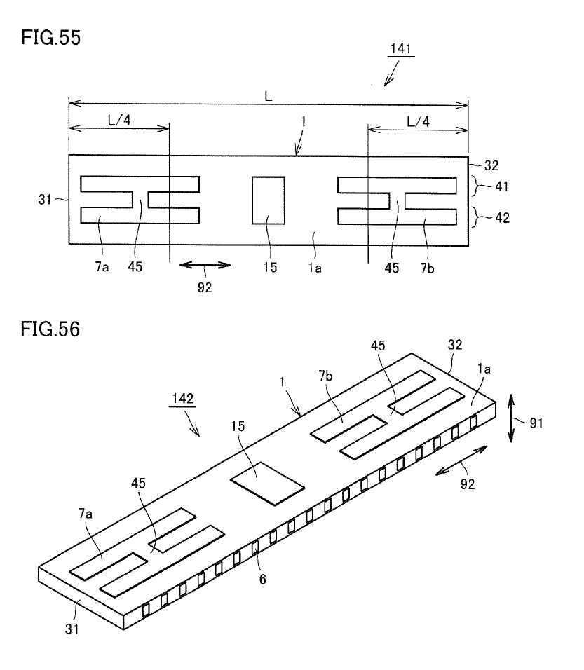

A coil antenna according to a sixth preferred embodiment the present invention will be described with reference to FIG. 53 and FIG. 54. FIG. 53 is a perspective view when seen from a direction in which the first main surface 1a of a coil antenna 141 according to the present preferred embodiment is viewed. FIG. 54 is a perspective view in a turned-over state thereof. In FIG. 54, the second main surface 1b of the coil antenna 141 is viewed. FIG. 55 is a plan view when the side of the first main surface 1a of the coil antenna 141 is seen from above. The basic configuration of the coil antenna 131 is common to that of the coil antenna 111 according to the third preferred embodiment. The coil antenna 131 includes no dummy electrode 8 on the first main surface 1a unlike the coil antenna 111.

The first terminal 7a, the second terminal 7b, and the center conductor pattern 15 are provided on the first main surface 1a of the coil antenna 141 according to the present preferred embodiment. Each of the first terminal 7a and the second terminal 7b preferably has an H shape. The first terminal 7a and the second terminal 7b may have the same or substantially the same shape. The first terminal 7a and the second terminal 7b do not necessarily have the exact same shape. The shape of the first terminal 7a and the shape of the second terminal 7b may have a mirror-image symmetrical relationship. As illustrated in FIG. 55, the first terminal 7a includes both of a portion belonging to the first row and a portion belonging to the second row 42. The second terminal 7b also includes both of a portion belonging to the first row 41 and a portion belonging to the second row 42. The first terminal 7a and the second terminal 7b are electrically isolated from each other.

The coil antenna 141 includes, on the first main surface 1a, first portions 45 that electrically connect the first row 41 and the second row 42 in a state in which the first terminal 7a and the second terminal 7b are electrically isolated from each other. The first portion 45 connects the portion of the first terminal 7a, which belongs to the first row 41, and the portion thereof, which belongs to the second row 42. The first portion 45 connects the portion of the second terminal 7b, which belongs to the first row 41, and the portion thereof, which belongs to the second row 42.

Also in the configuration in which the first terminal 7a and the second terminal 7b have the H shapes and are aligned along the lengthwise direction 92 as in the coil antenna 141 illustrated in FIG. 55, the first terminal 7a covers at least a portion of a point at an L/4 position from the one end 31 of the first main surface 1a in the lengthwise direction 92 when the length of the first main surface 1a in the lengthwise direction 92 is L. The second terminal 7b covers at least a portion of a point at an L/4 position from the other end 32 of the first main surface 1a in the lengthwise direction 92.

In the present preferred embodiment, each of the first terminal 7a and the second terminal 7b extends along the lengthwise direction 92, thus the coil antenna has resistance to warpage in the lengthwise direction 92. Furthermore, each of the first terminal 7a and the second terminal 7b includes the first portion 45 connecting the portion belonging to the first row 41 and the portion belonging to the second row 42, thus the coil antenna has resistance to warpage also in the direction perpendicular or substantially perpendicular to the lengthwise direction 92. Each of the first terminal 7a and the second terminal 7b has the H shape, thus the coil antenna has resistance to deformation of a twist mode.

Although the first portion 45 is preferably located at the center or approximate center of the first terminal 7a in the present preferred embodiment, the first portion 45 is not limited to being located at the center or approximate of the first terminal 7a and may be located at a position shifted to either of the sides.

The same holds true for the position of the first portion 45 of the second terminal 7b.

Although the first portion 45 preferably has a simple shape linearly connecting the first row 41 and the second row 42 in the present preferred embodiment, the first portion 45 is not limited to be linear and may have a curved or bent shape, for example. The first portion 45 is not limited to extending in the direction perpendicular or substantially perpendicular to the lengthwise direction 92 and may connect the first row 41 and the second row 42 by extending in another direction.

These points are applied to not only the present preferred embodiment but also the following preferred embodiments in the same or similar manner.

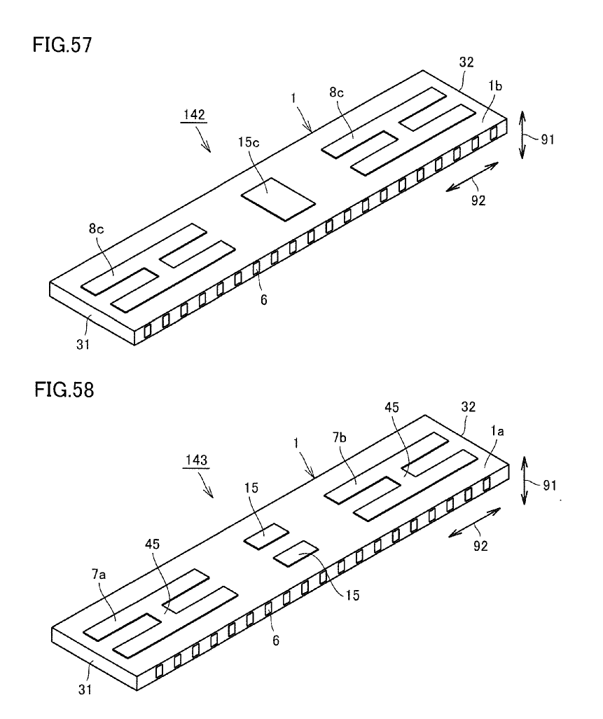

As a first variation of the coil antenna according to the sixth preferred embodiment, a coil antenna 142 illustrated in FIG. 56 and FIG. 57 may also be considered. FIG. 56 is a perspective view when seen from a direction in which the first main surface 1a of the coil antenna 142 is viewed and FIG. 57 is a perspective view in a turned-over state thereof. In the coil antenna 142, the plurality of interlayer connection conductor assemblies 6 are exposed at the side surfaces and electrodes are provided on the second main surface 1b in a mirror-image symmetrical manner with the electrodes provided on the first main surface 1a. The two second main surface dummy electrodes 8c having H shapes are provided on the second main surface 1b. The center conductor pattern 15c is arranged at the center or approximate center of the second main surface 1b.

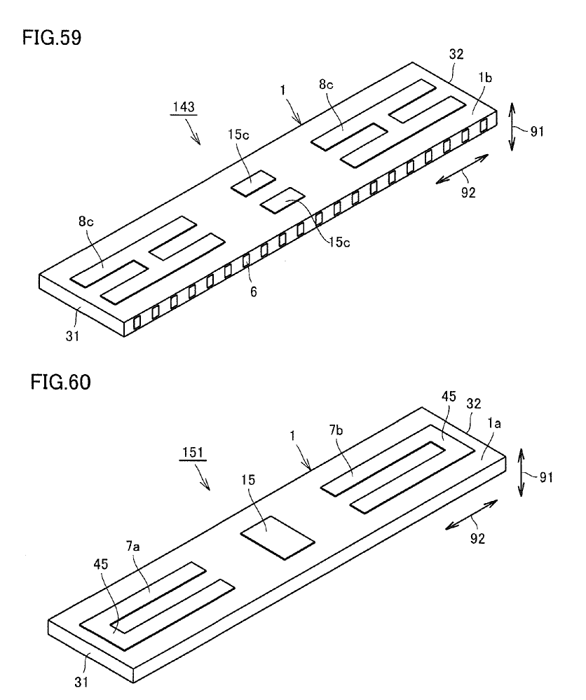

As a second variation of the coil antenna according to the sixth preferred embodiment, a coil antenna 143 illustrated in FIG. 58 and FIG. 59 may be considered. FIG. 58 is a perspective view when seen from a direction in which the first main surface 1a of the coil antenna 143 in viewed and FIG. 59 is a perspective view in a turned-over state thereof. The two center conductor patterns 15 are arranged at the center of the first main surface 1a. The two center conductor patterns 15 preferably have the same or substantially the same shape and are disposed parallel or substantially parallel to each other. The lengthwise direction of the center conductor patterns 15 is parallel or substantially parallel to the lengthwise directions of the first terminal 7a and the second terminal 7b. The width of the center conductor patterns 15 is preferably equal or substantially equal to the widths of portions of the first terminal 7a and the second terminal 7b, which project in the lengthwise direction.

In the coil antenna 143, the plurality of interlayer connection conductor assemblies 6 are exposed at the side surfaces. Electrodes are provided on the second main surface 1b of the coil antenna 143 in a mirror-image symmetrical manner with the electrodes provided on the first main surface 1a. Each of two H-shaped electrodes arranged on the second main surface 1b is the second main surface dummy electrode 8c. The two center conductor patterns 15c are provided at the center or approximate center of the second main surface 1b. The two center conductor patterns 15c may preferably be dummy electrodes. These are merely examples and the configuration in which no interlayer connection conductor assembly 6 is provided on the side surfaces may also be used. The configuration in which no electrode is provided on the second main surface 1b may also be used.

### Seventh Preferred Embodiment

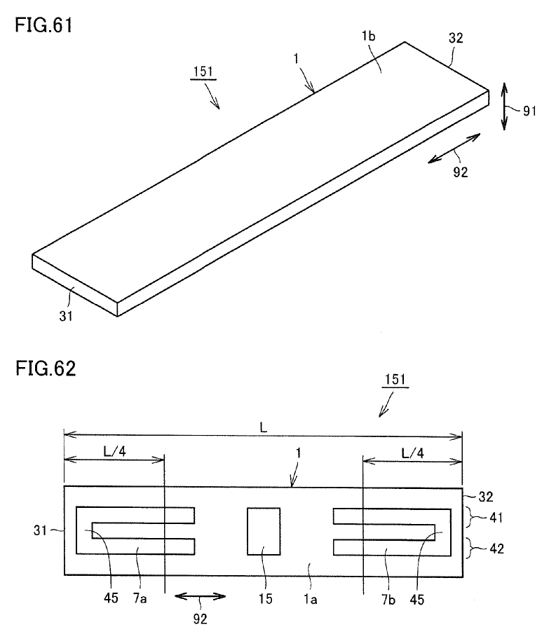

A coil antenna according to a seventh preferred embodiment of the present invention will be described with reference to FIG. 60 to FIG. 62. FIG. 60 is a perspective view when seen from a direction in which the first main surface 1a of a coil antenna 151 according to the present preferred embodiment is viewed. FIG. 61 is a perspective view in a turned-over state thereof. In FIG. 61, the second main surface 1b of the coil antenna 151 is viewed. FIG. 62 is a plan view when the side of the first main surface 1a of the coil antenna 151 is seen from above. The basic configuration of the coil antenna 151 is common to that of the coil antenna 141 according to the sixth preferred embodiment. In the coil antenna 151, each of the first terminal 7a and the second terminal 7b preferably has a U shape. The first terminal 7a and the second terminal 7b are disposed with open sides of the U shapes respectively facing inward in the lengthwise direction 92. Accordingly, the open sides of the U shapes of the first terminal 7a and the second terminal 7b (portions corresponding to the upper ends of characters “U”) face each other.

The shape of the first terminal 7a and the shape of the second terminal 7b preferably have a mirror-image symmetrical relationship. It should be noted that the first terminal 7a and the second terminal 7b are not necessarily entirely symmetrical to each other. This is applied to not only the present preferred embodiment but also the eighth preferred embodiment.

Also in the present preferred embodiment, as illustrated in FIG. 62, the first terminal 7a covers at least a portion of a point at an L/4 position from the one end 31 of the first main surface 1a in the lengthwise direction 92 when the length of the first main surface 1a in the lengthwise direction 92 is L. The first terminal 7a extends in the lengthwise direction 92 across the forward and backward sides of the L/4 position from the one end 31. The second terminal 7b covers at least a portion of a point at an L/4 position from the other end 32 of the first main surface 1a in the lengthwise direction 92. The second terminal 7b extends in the lengthwise direction 92 across the forward and backward sides of the L/4 position from the other end 32.

Also in the present preferred embodiment, the same or similar effects as those in the sixth preferred embodiment are obtained. When both ends of the coil antenna in the lengthwise direction 92 tend to warp in the direction farther from a mounting target surface in a state in which the coil antenna is placed on the mounting target surface, in the present preferred embodiment, the coil antenna is bonded to a substrate in a divided manner into two rows in portions close to a center portion because the first portions 45 are located at positions close to both ends and the portions close to the center portion are divided into the first row 41 and the second row 42. Therefore, a mounting posture thereof is stable.

Although each of the first terminal 7a and the second 7b preferably has the U shape in the present preferred embodiment, the shape may be regarded as a state in which as a result of deviation of the positions of the first portions 45 in the sixth preferred embodiment toward both ends, the first portions 45 have reached to the respective outermost portions of the first terminal 7a and the second terminal 7b. Although the expression “U shape” is used herein, it is not limited to a rounded U shape and may be an angulated U shape as described in the present preferred embodiment. These points are applied to not only the present preferred embodiment but also the eighth preferred embodiment and subsequent preferred embodiments in the same or similar manner.

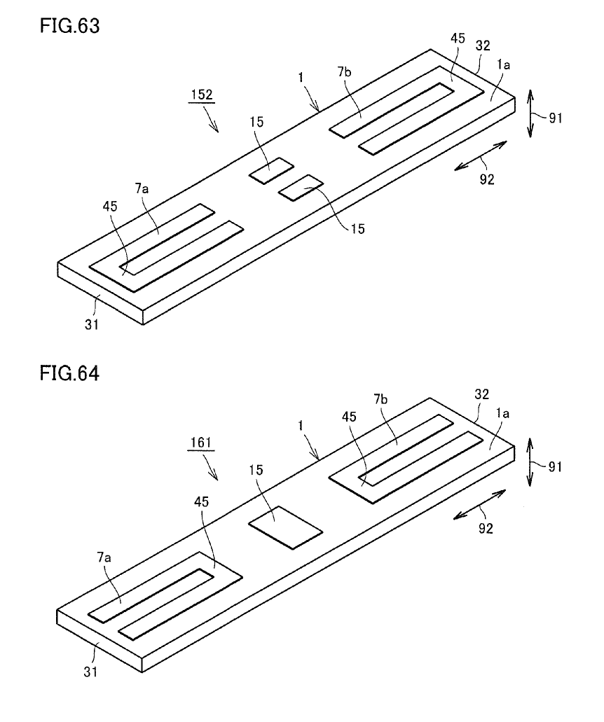

As a variation of the coil antenna according to the seventh preferred embodiment, a coil antenna 152 illustrated in FIG. 63 may be considered. FIG. 63 is a perspective view when seen from a direction in which the first main surface 1a of the coil antenna 152 is viewed. The two center conductor patterns 15 are located at the center or approximate center of the first main surface 1a. The two center conductor patterns 15 have the same or substantially the same shape and are arranged parallel or substantially parallel to each other. The lengthwise direction of the center conductor patterns 15 is parallel or substantially parallel to the lengthwise directions of the first terminal 7a and the second terminal 7b. The width of the center conductor patterns 15 is preferably equal or substantially equal to the widths of portions of the first terminal 7a and the second terminal 7b, which project in the lengthwise direction.

Electrodes may be provided on the second main surface 1b of the coil antenna 152 in a mirror-image symmetrical manner with the electrodes arranged on the first main surface 1a. The configuration in which no electrode is provided on the second main surface 1b may be used. Although the plurality of interlayer connection conductor assemblies 6 are not exposed at the side surfaces herein as an example, the plurality of interlayer connection conductor assemblies 6 may be exposed at the side surfaces.

### Eighth Preferred Embodiment

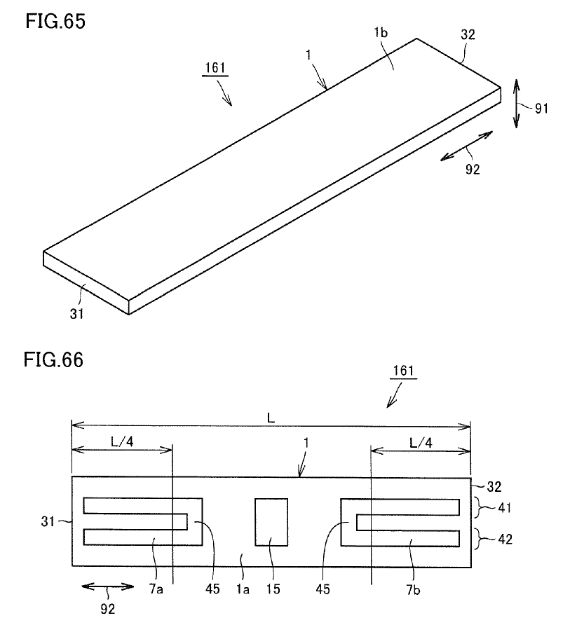

A coil antenna according to an eighth preferred embodiment of the present invention will be described with reference to FIG. 64 to FIG. 66. FIG. 64 is a perspective view when seen from a direction in which the first main surface 1a of a coil antenna 161 according to the present preferred embodiment is viewed. FIG. 65 is a perspective view in a turned-over state thereof. In FIG. 65, the second main surface 1b of the coil antenna 161 is viewed. FIG. 66 is a plan view when the side of the first main surface 1a of the coil antenna 161 is seen from above. The basic configuration of the coil antenna 161 is common to that of the coil antenna 151 according to the seventh preferred embodiment. In the coil antenna 161 according to the present preferred embodiment, each of the first terminal 7a and the second terminal 7b preferably has a U shape in the same or similar manner as in the coil antenna 151 except the orientation thereof is different. In the coil antenna 161 according to the present preferred embodiment, the first terminal 7a and the second terminal 7b are arranged with open sides of the U shapes respectively facing outward in the lengthwise direction 92. Accordingly, close sides of the U shapes of the first terminal 7a and the second terminal 7b (portions corresponding to the lower ends of characters “U”) face each other.

Also in the present preferred embodiment, as illustrated in FIG. 66, the first terminal 7a covers at least a portion of a point at an L/4 position from the one end 31 of the first main surface 1a in the lengthwise direction 92 when the length of the first main surface 1a in the lengthwise direction 92 is L. The first terminal 7a extends in the lengthwise direction 92 across the forward and backward sides of the L/4 position from the one end 31. The second terminal 7b covers at least a portion of a point at an L/4 position from the other end 32 of the first main surface 1a in the lengthwise direction 92. The second terminal 7b extends in the lengthwise direction 92 across the forward and backward sides of the L/4 position from the other end 32.

Also in the present preferred embodiment, the same or similar effects as those according to the sixth preferred embodiment are obtained. When a center portion of the coil antenna in the lengthwise direction 92 tends to warp in the direction of being farther from a mounting target surface in a state in which the coil antenna overall is placed on the mounting target surface, in the present preferred embodiment, the coil antenna is bonded to a substrate in a divided manner into two rows in portions close to both ends because the first portions 45 are located at positions close to the center and the portions close to both ends are divided into the first row 41 and the second row 42. Therefore, a mounting posture thereof is stable.

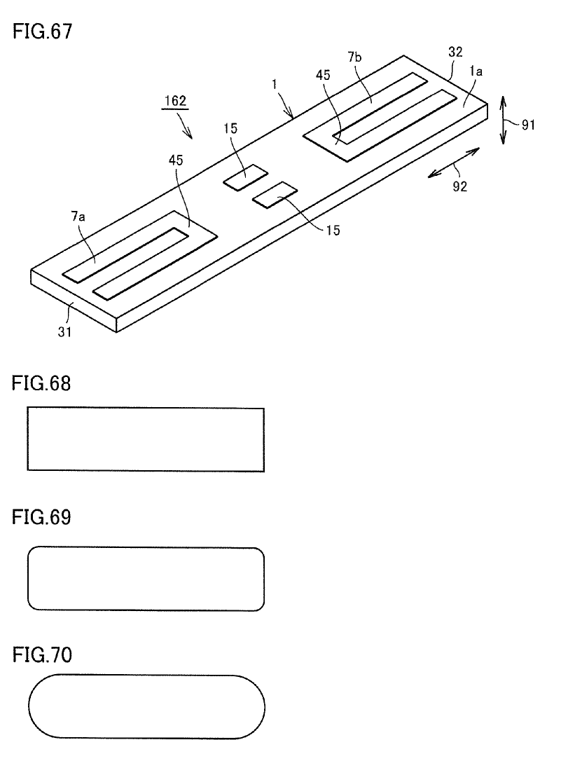

As a variation on the coil antenna according to the eighth preferred embodiment, a coil antenna 162 illustrated in FIG. 67 may be considered. FIG. 67 is a perspective view when seen from a direction in which the first main surface 1a of the coil antenna 162 is viewed. The two center conductor patterns 15 are provided at the center or approximate center of the first main surface 1a. The two center conductor patterns 15 preferably have the same or substantially the same shape and are disposed parallel or substantially parallel to each other. The lengthwise direction of the center conductor patterns 15 is parallel or substantially parallel to the lengthwise directions of the first terminal 7a and the second terminal 7b. The width of the center conductor patterns 15 is preferably equal or substantially equal to the widths of portions of the first terminal 7a and the second terminal 7b, which project in the lengthwise direction.

Electrodes may be provided on the second main surface 1b of the coil antenna 162 in a mirror-image symmetrical manner with the electrodes arranged on the first main surface 1a. The configuration in which no electrode is Although the plurality of interlayer connection conductor assemblies 6 are not exposed at the side surfaces herein as an example, the plurality of interlayer connection conductor assemblies 6 may be exposed at the side surfaces.

Although each of the first terminal 7a and the second terminal 7b preferably has the “band shape” in some of the preferred embodiments, the band shape is not limited to the rectangular or substantially rectangular shape such as that of the first terminal 7a and the second terminal 7b illustrated in FIG. 30, FIG. 41, or FIG. 50. That is to say, the “band shape” is not limited to the rectangular or substantially rectangular shape as illustrated in FIG. 68 and may be a shape with rounded corners as illustrated in FIG. 69. Furthermore, it may be a shape with semicircular corners as illustrated in FIG. 70. Moreover, sides of intermediate portions are not limited to being perfectly parallel linear sides and a portion or all of the sides may be somewhat deformed. The same is true for other conductor patterns than the first terminal 7a and the second terminal 7b.

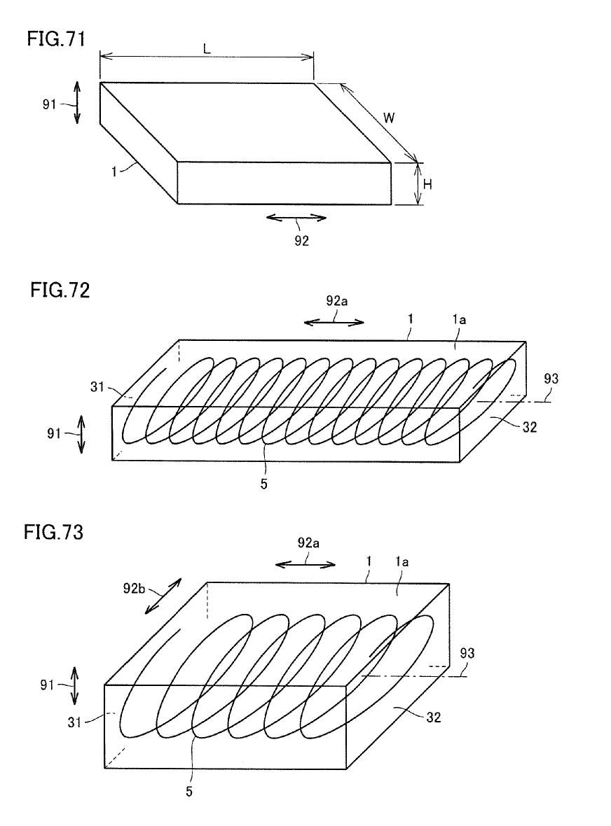

As illustrated in FIG. 71, the dimension of the outer shape of the multilayer body 1 in the lamination direction 91 is denoted as H and the dimensions of two sides in the direction perpendicular or substantially perpendicular to the lamination direction are denoted as L and W in the order from the longer one to the shorter one. In this case, L is the dimension in the lengthwise direction 92 and W is the dimension in the width direction. When the dimension of the multilayer body 1 in the width direction is W and the dimension thereof in the lamination direction 91 is H, a relation of L>W>H is preferable. This condition is preferably applied to all of the above-described preferred embodiments of the present invention. When this relationship is satisfied, a mode in which the multilayer body 1 is bent about an axis in parallel or substantially in parallel with the sides having the length L or the sides having the length H is more difficult to be generated than a mode in which the multilayer body 1 is bent about an axis in parallel or substantially in parallel with the sides having the length W. This configuration makes it difficult to cause a case in which the conductor pattern of the substrate and the conductor pattern of the multilayer body are not identical to each other in the direction in parallel or substantially in parallel with the substrate mounting surface when mounting on the substrate, for example. Even when the multilayer body 1 is bent about the axis in parallel or substantially in parallel with the sides having the length W, it can be mounted as described in the above-described preferred embodiments, thus ensuring electrical connection.

In the first to eighth preferred embodiments of the present invention, as illustrated in FIG. 72, the winding axis 93 of the coil conductor 5 is the direction perpendicular or substantially perpendicular to the lamination direction 91 as an example. As described in the first and second preferred embodiments, the winding axis 93 of the coil conductor 5 is preferably along the direction perpendicular or substantially perpendicular to the lamination direction 91. This configuration easily enables a coil conductor having the large number of windings with a reduced height. This is not limited to the case of an elongated shape as illustrated in FIG. 72 and the same is true for the case of a shape as illustrated in FIG. 73. In FIG. 73, the multilayer body 1 has a square or substantially square shape when seen from above. In the case of this shape, the lengthwise direction is not uniquely defined but any of directions 92a and 92b may be regarded as the lengthwise direction.

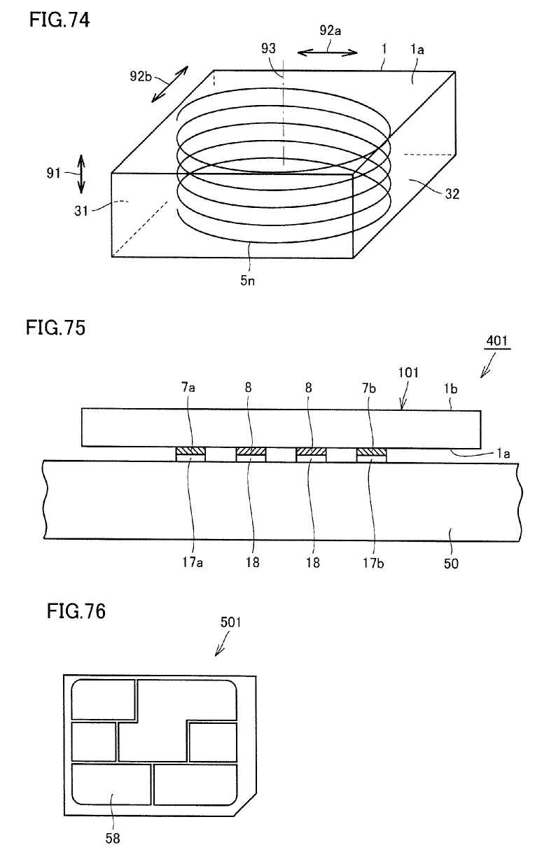

However, the direction of the winding axis 93 is not limited thereto. For example, as illustrated in FIG. 74, a coil conductor 5n may be included. That is to say, the winding axis 93 of the coil conductor 5n may be in parallel or substantially in parallel with the lamination direction 91 of the multilayer body 1. Even this configuration provides a coil antenna. The coil antenna having this configuration may have a square or substantially square outer shape when seen from the above and any of the directions 92a and 92b may be regarded as the lengthwise direction also in this configuration. It is sufficient that the first terminal covers at least a portion of a point at an L/4 position from one end of the first main surface 1a in the lengthwise direction when an appropriate lengthwise direction is set and the length thereof in the lengthwise direction is L. It is sufficient that the second terminal covers at least a portion of a point at an L/4 position from the other end of the first main surface 1a in the lengthwise direction. Even when the winding axis of the coil conductor is in parallel or substantially in parallel with the lamination direction of the multilayer body, the multilayer body is not limited to having the square or substantially square shape when seen from above and may have an elongated shape.

It is preferable that no conductive body be arranged on the side surfaces perpendicular or substantially perpendicular to the winding axis of the coil conductor. For example, in the example illustrated in FIG. 72, the side surfaces perpendicular or substantially perpendicular to the winding axis 93 of the coil conductor 5 indicate end surfaces at the one end 31 and the other end 32. For example, in the coil antenna 101 described in the first preferred embodiment, no conductive body is provided on these end surfaces. Also in the second to eighth preferred embodiments, no conductive body is provided on the side surfaces perpendicular to the winding axis 93 of the coil conductor 5. When no conductive body is provided on the side surfaces perpendicular or substantially perpendicular to the winding axis, a magnetic flux generated by the coil conductor is avoided from being blocked by the conductive body and it is therefore preferable. In an example in which the direction of the winding axis is different, that is, in the case in which the lamination direction 91 and the winding axis 93 of the coil conductor 5n are parallel or substantially parallel to each other as in the example illustrated in FIG. 74, for example, the same is also applicable. Accordingly, in the example illustrated in FIG. 74, it is preferable that no conductive body be provided on the upper and lower surfaces of the multilayer body 1.

It is preferable that no magnetic layer be provided in an outer side portion of the coil conductor when the multilayer body 1 is seen from the winding axis of the coil conductor. In the examples illustrated in FIG. 5 and FIG. 10, no magnetic layer is provided although the non-magnetic layers are provided in the outer side portions of the coil conductor in some cases. This configuration causes the magnetic flux that is generated by the coil conductor to efficiently spread and is therefore preferable.

### Ninth Preferred Embodiment

A coil-mounted substrate according to a ninth preferred embodiment of the present invention will be described with reference to FIG. 75. FIG. 75 is a side view of a coil-mounted substrate 401 according to the present preferred embodiment. The coil-mounted substrate 401 includes the substrate 50 and the coil antenna 101. Electrodes 17a and 17b and two electrodes 18 are provided on the surface of the substrate 50. The coil antenna 101 is mounted on the substrate 50 such that the first main surface 1a faces the side of the substrate 50. The first terminal 7a is connected to the electrode 17a. The second terminal 7b is connected to the electrode 17b. The dummy electrodes 8 are respectively connected to the electrodes 18. That is to say, electrodes corresponding to the first terminal 7a, the second terminal 7b, and the dummy electrodes 8 of the coil antenna 101 are provided on the substrate 50. The electrodes provided on the substrate 50 so as to correspond to the first terminal 7a, the second terminal 7b, and the dummy electrodes 8 respectively preferably have the same or substantially the same shapes as those of the first terminal 7a, the second terminal 7b, and the dummy electrodes 8, for example. It should be noted that although the coil-mounted substrate 401 includes the coil antenna 101 in this example, it may include another coil antenna described above instead of the coil antenna 101.

As described in the present preferred embodiment, the coil-mounted substrate preferably includes the coil antenna having any one of the above-described configurations.

With the present preferred embodiment, a coil-mounted substrate having high reliability is provided because it includes the coil antenna that enables reliable connection of the electrodes when the coil antenna is mounted on the substrate even if the warpage is generated.

### Tenth Preferred Embodiment

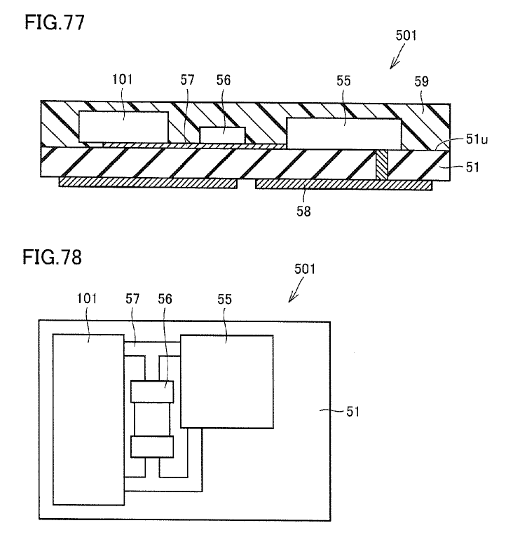

A recording medium according to a tenth preferred embodiment of the present invention will be described with reference to FIG. 76 to FIG. 78. FIG. 76 is a plan view of a recording medium 501 according to the present preferred embodiment. The recording medium 501 is preferably a plate-shaped medium and has a shape provided by chamfering one corner of a rectangular shape. The recording medium 501 includes six electrodes 58 on one surface. It should be noted that the outer shape, the number of electrodes, the shape, and the arrangement of the recording medium as described herein are merely examples and are not limited thereto. FIG. 77 is a cross-sectional view of the recording medium 501. The recording medium 501 includes a substrate 51 and the coil antenna 101. A wiring 57 is defined by a metal film on one surface 51u of the substrate 51. In addition to the coil antenna 101, a capacitor 56 and an RFIC (Radio Frequency Integrated Circuit) 55 are also mounted on the surface 51u. FIG. 78 is a see-through plan view when the surface 51u is seen from above in FIG. 77. The coil antenna 101, the capacitor 56, and the RFIC 55 are connected to each other with the wiring 57. As illustrated in FIG. 77, these are covered with a resin mold portion 59. As illustrated in FIG. 77, the electrodes 58 are provided on the surface of the substrate 51 at the opposite side to the surface 51u. Although FIG. 78 also illustrates the substrate 51, in actuality, the coil antenna 101, the capacitor 56, the RFIC 55, and the wiring 57 are provided on the surface of the substrate 51 at the side distant from the paper plane. The electrodes 58 are provided on the surface of the substrate 51 at the side near the paper plane. FIG. 78 illustrates only main components and components, wirings, and elements other than those illustrated may be provided on the substrate 51.

As described in the present preferred embodiment, the recording medium preferably includes the coil antenna having any one of the above-described configurations.

With the present preferred embodiment, a recording medium having high reliability is provided because it includes the coil antenna that enables connection of the electrodes when the coil antenna is mounted on the substrate even if warpage is generated.

The recording medium according to the present preferred embodiment may preferably be, for example, a SIM card, an SD memory card, or another suitable recording medium. The concept of the SIM card covers a standard SIM card, a mini SIM card, a micro SIM card, and a nano SIM card. The concept of the SD memory card covers the SD memory card, an SDHC (registered trademark) card, an SDXC (registered trademark) card, a microSD (registered trademark) card, a microSDHC (registered trademark) card, and a microSDXC (registered trademark) card.

### Eleventh Preferred Embodiment

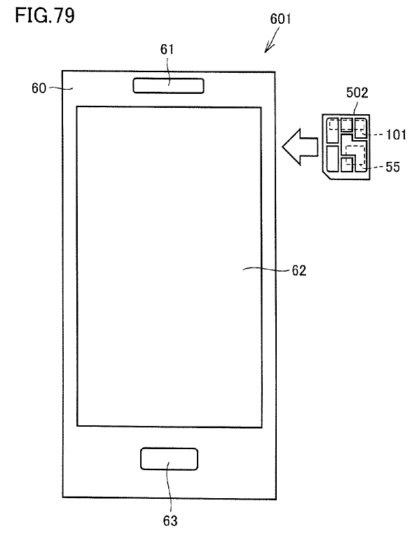

An electronic apparatus according to an eleventh preferred embodiment of the present invention will be described with reference to FIG. 79. FIG. 79 is a conceptual view of an electronic apparatus 601 according to the present preferred embodiment. The electronic apparatus 601 includes a housing 60, a speaker 61, a display 62, and a button 63. The display 62 may also function as a touch panel. The touch panel may be included instead of the display 62. The presence or absence, the shapes, the numbers, and the positions of the speaker 61 and the button 63 are merely examples and are not limited thereto.

The electronic apparatus 601 includes a detachable card module 502. The card module 502 includes the coil antenna 101 and the RFIC 55. Desired functions may be added to the electronic apparatus 601 by mounting the card module 502 thereon. For example, even when an original electronic apparatus does not have an NFC (Near Field Communication) function, a communication terminal having the NFC function is able to be provided by mounting the card module 502 thereon. As a reason for this, magnetic coupling with a communication party is able to be made by the coil antenna 101 included in the card module 502. The card module 502 may be the same as the recording medium 501.

As described in the present preferred embodiment, the electronic apparatus preferably includes the coil antenna having any one of the above-described configurations or the above-described recording medium.

With the present preferred embodiment, an electronic apparatus having high reliability is provided because it includes the coil antenna that enables connection of the electrodes when the coil antenna is mounted on the substrate even if warpage is generated. In the electronic apparatus according to the present preferred embodiment, the module including the coil antenna is detachable and the module is able to therefore be replaced, if necessary.

### Twelfth Preferred Embodiment

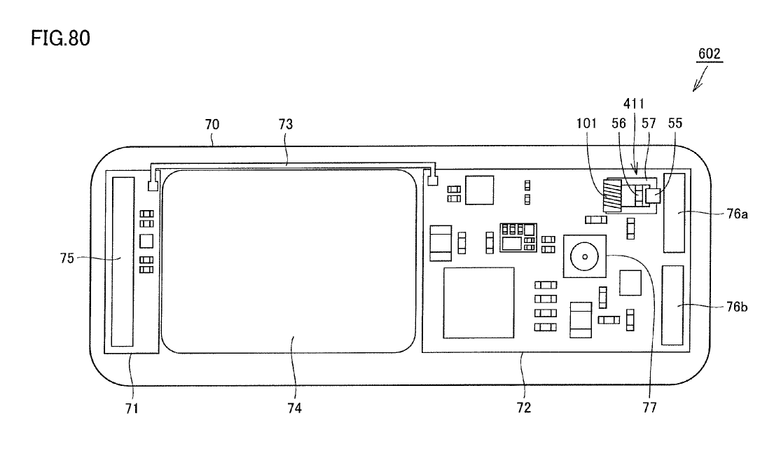

An electronic apparatus according to a twelfth preferred embodiment of the present invention will be described with reference to FIG. 80. FIG. 80 is a conceptual view of an electronic apparatus 602 according to the present preferred embodiment.

The electronic apparatus 602 according to the present preferred embodiment includes therein an antenna device 411. As illustrated in FIG. 80, the electronic apparatus 602 includes a housing 70, printed wiring boards 71 and 72, a coaxial cable 73, and a battery pack 74. The printed wiring boards 71 and 72, the coaxial cable 73, and the battery pack 74 are disposed in the housing 70. A UHF antenna 75 is mounted on the surface of the printed wiring board 71. The coaxial cable 73 connects the printed wiring boards 71 and 72. In addition to the antenna device 411, UHF antennas 76a and 76b, a camera 77, and other elements are mounted on the surface of the printed wiring board 72. Various components other than those described explicitly herein may be provided on the respective surfaces of the printed wiring boards 71 and 72.

The configuration of the antenna device 411 corresponds to the configuration of the card module 502 described according to the eleventh preferred embodiment. The antenna device 411 includes the coil antenna 101, the RFIC 55, and the capacitor 56. These components are directly mounted on the surface of the printed wiring board 72. The antenna device 411 includes the wiring 57 to connect these components to one another. The wiring 57 is directly provided on the surface of the printed wiring board 72.

With the present preferred embodiment, an electronic apparatus having high reliability is provided because it includes the coil antenna that enables connection of the electrodes when the coil antenna is mounted on the substrate even if warpage is generated.

Although the electronic apparatuses 601 and 602 described according to the eleventh and twelfth preferred embodiments include the coil antenna 101, the included coil antenna is not limited to the coil antenna 101 and may be the coil antenna having any one of the above-described configurations.

The configurations of the electronic apparatuses 601 and 602 according to the eleventh and twelfth preferred embodiments are merely examples and are not limited thereto. The electronic apparatuses 601 and 602 may be a cellular phone, a smart phone, a tablet terminal, a wearable terminal, a camera, or a game machine, for example.

In the electronic apparatuses 601 and 602 according to the eleventh and twelfth preferred embodiments, a booster coil may be provided in addition to the coil antenna and the coil antenna may be used as a power feeding coil. When the housing is conductive, the housing may be used as a booster or a radiator by magnetically coupling the coil antenna as the power feeding coil to the housing. A film conductor may be provided close to the coil antenna and the film conductor may be used as the booster or the radiator.

It should be noted that a plurality of preferred embodiments among the above-described preferred embodiments of the present invention may be appropriately combined or modified.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A coil antenna comprising:
a multilayer body including a first main surface which faces an outer side portion and is perpendicular or substantially perpendicular to a lamination direction, and an insulating layer;
a coil conductor having a coil shape and defined by a conductive body provided in the multilayer body or on a surface of the multilayer body, at least a portion of the multilayer body defining a core;
a first terminal provided on the first main surface; and
a second terminal provided on the first main surface; wherein
the first terminal is electrically connected to a first connection point of the coil conductor;
the second terminal is electrically connected to a second connection point of the coil conductor; and
the first terminal and the second terminal are located between the first connection point and the second connection point when the multilayer body is seen from the lamination direction.

2. The coil antenna according to claim 1, wherein a winding axis of the coil conductor extends in a direction perpendicular or substantially perpendicular to the lamination direction.

3. The coil antenna according to claim 1, wherein the first terminal covers at least a portion of a point at an L/4 position from one end of the first main surface in a lengthwise direction and the second terminal covers at least a portion of a point at an L/4 position from the other end of the first main surface in the lengthwise direction when a length of the first main surface in the lengthwise direction is L.

4. The coil antenna according to claim 1, wherein at least one first main surface dummy electrode is provided on the first main surface in addition to the first terminal and the second terminal.

5. The coil antenna according to claim 4, wherein the at least one first main surface dummy electrode is provided only at positions between the first terminal and the second terminal.

6. The coil antenna according to claim 4, wherein a set of the first terminal, the second terminal, and the at least one first main surface dummy electrode are aligned on the first main surface in a matrix defined by a first side perpendicular or substantially perpendicular to a lengthwise direction of the multilayer body and a second side parallel or substantially parallel with the lengthwise direction of the multilayer body, and a number of the first terminal, the second terminal, and the at least one first main surface dummy electrode aligned along the first side is two or more.

7. The coil antenna according to claim 4, wherein a total number of the first terminal, the second terminal, and the at least one first main surface dummy electrode provided on the first main surface is four or eight.

8. The coil antenna according to claim 1, wherein each of the first terminal and the second terminal has a band shape extending along a lengthwise direction of the first main surface and lengths of the first terminal and the second terminal along the lengthwise direction of the first main surface are equal or substantially equal to each other.

9. The coil antenna according to claim 8, wherein the first terminal is a conductor pattern, the second terminal is a conductor pattern, a set of all of conductor patterns provided on the first main surface includes a first row and a second row extending along the lengthwise direction of the first main surface, and the first row and the second row are aligned in a direction perpendicular or substantially perpendicular to the lengthwise direction of the first main surface.

10. The coil antenna according to claim 9, wherein the first terminal is in the first row and the second terminal is in the second row.

11. The coil antenna according to claim 9, wherein a first portion that electrically connects the first row and the second row in a state in which the first terminal and the second terminal are electrically isolated from each other is provided on the first main surface.

12. The coil antenna according to claim 8, wherein a center conductor pattern is provided at a center or an approximate center of the first main surface, and the first terminal and the second terminal are separated from the center conductor pattern and the center conductor pattern is interposed between the first and second terminals.

13. The coil antenna according to claim 1, wherein the multilayer body includes a second main surface facing an opposite side to the first main surface and electrodes are provided on the second main surface in a mirror-image symmetrical manner with electrodes provided on the first main surface.

14. The coil antenna according to claim 1, wherein the coil conductor includes an interlayer connection conductor exposed at a side surface of the multilayer body along the lamination direction of the multilayer body.

15. The coil antenna according to claim 1, wherein the multilayer body includes a magnetic layer.

16. The coil antenna according to claim 15, wherein the multilayer body includes the magnetic layer in a region in which the coil conductor is provided and includes a non-magnetic layer at at least one of an upper side and a lower side relative to the coil conductor when the multilayer body is viewed such that the lamination direction is an up-down direction.

17. The coil antenna according to claim 1, wherein L>W>H is satisfied when a dimension of the multilayer body in a lengthwise direction is L, a dimension of the multilayer body in a width direction is W, and a dimension of the multilayer body in the lamination direction is H.

18. The coil antenna according to claim 1, wherein no conductive body is provided on a side surface perpendicular or substantially perpendicular to a winding axis of the coil conductor.

19. The coil antenna according to claim 15, wherein no magnetic layer is provided in an outer side portion of the coil conductor when the multilayer body is seen from a winding axis of the coil conductor.

20. A coil-mounted substrate comprising the coil antenna according to claim 1.

21. A recording medium comprising the coil antenna according to claim 1.

22. An electronic apparatus comprising the coil antenna according to claim 1.

23. An electronic apparatus comprising the recording medium according to claim 21.
